(19) United States
(12) Patent Application Publication
(10) Pub. No.: US 2025/0266927 A1
(43) Pub. Date: Aug. 21, 2025

(54) Polar Code Segment Encoding Method and Communication Device

(71) Applicant: HUAWEI TECHNOLOGIES CO., LTD., Shenzhen (CN)

(72) Inventors: Shengchen DAI, Hangzhou (CN); Jiajie TONG, Hangzhou (CN); Zhan YU, Singapore (SG); Kai FU, Singapore (SG); Rong LI, Boulogne Billancourt (FR); Jun WANG, Hangzhou (CN)

(21) Appl. No.: 19/064,016

(22) Filed: Feb. 26, 2025

Related U.S. Application Data
(63) Continuation of application No. 18/401,019, filed on Dec. 29, 2023, now Pat. No. 12,267,161.
Application No. 18/401,019 is a continuation of application No. 17/704,869, filed on Mar. 25, 2022, now Pat. No. 11,888,614.
Application No. 17/704,869 is a continuation of application No. PCT/CN2020/113950, filed on Sep. 8, 2020.

(30) Foreign Application Priority Data
Sep. 27, 2019 (CN) 201910927225.4

(51) Int. Cl. H04L 1/00

(52) U.S. Cl. CPC H04L 1/0057; H04L 1/0007; H04L 1/0041

(57) ABSTRACT

Methods, devices, and computer-readable storage media are disclosed. In an example method, segmentation of to-be-encoded information bits of a length N into respective quantities of different types of segments is performed. The different types of segments are among (b−a+1) types of segments that correspond to (b−a+1) different segment code lengths. The (b−a+1) types of segments comprise a minimum-length segment that has the minimum segment code length of 2\hat{ }^{a} and a maximum-length segment that has the maximum segment code length of 2\hat{ }^{b}. The respective quantities of the different types of segments are determined based on the length N and a code rate in an orderly manner, wherein the orderly manner comprises firstly determining a quantity of the maximum-length segments and lastly determining a quantity of the minimum-length segments. Polar code encoding is performed on the respective quantities of the different types of segments of the to-be-encoded information bits.

### CROSS-REFERENCE TO RELATED APPLICATIONS

This application is a continuation of U.S. patent application Ser. No. 18/401,019, filed on Dec. 29, 2023, which is a continuation of U.S. patent application Ser. No. 17/704,869, filed on Mar. 25, 2022, now U.S. Pat. No. 11,888,614, which is a continuation of International Application No. PCT/CN2020/113950, filed on Sep. 8, 2020. The International Application claims priority to Chinese Patent Application No. 201910927225.4, filed on Sep. 27, 2019. All of the afore-mentioned patent applications are hereby incorporated by reference in their entireties.

### TECHNICAL FIELD

This application relates to the field of electronic technologies, and in particular, to a polar code segment encoding method and a communication device.

### BACKGROUND

For a communication system that is very sensitive to a delay, after receiving data, a receive end device needs to complete processing of the data in a very short time and reply with an acknowledgment character ACK (Acknowledgment). For example, in a Bluetooth system, an interval between a time point at which a mobile phone completes sending data and a time point at which the mobile phone receives an ACK of a primary headset is 189 μs, and after the primary headset and a secondary headset receive all information sent by the mobile phone, there is a 15 μs time margin for decoding and data reporting. For a system that requires low power consumption, for example, a Bluetooth system, power of information reporting is usually limited. Consequently, a reporting rate of information bits is further limited. Currently, the Bluetooth system usually uses an encoding manner in which no channel code or convolutional code is used. When there is no code, a receive end may report received data while making a judgment, to meet a limit of completing decoding and data reporting in 15 μs. However, performance of the Bluetooth system is poor. When convolutional code is used, because a decoding algorithm of the convolutional code is a Viterbi decoding algorithm, the Viterbi decoding algorithm with traceback may also meet the limit of completing decoding and data reporting in 15 μs. However, the performance of the Bluetooth system needs to be further improved. For ease of description, in this application, duration from a time point at which all data sent by the mobile phone is received by the primary headset and/or the secondary headset to a time point at which the primary headset and/or the secondary headset continues to perform decoding and reporting is referred to as a delay of decoding and reporting, and the delay of decoding and reporting needs to meet a 15 μs margin limit.

In conclusion, in an existing encoding manner, performance of a low-power communication system cannot be effectively improved when a delay limit of decoding and reporting is met.

### SUMMARY

Embodiments of this application provide a polar code segment encoding method and a communication device, to effectively improve performance of a low-power communication system when a delay limit of decoding and reporting is met.

According to a first aspect, this application provides a polar code segment encoding method, including: determining, based on a length of to-be-encoded information bits and a code rate, a code length N after encoding, where N is a positive integer; determining, based on N, a minimum segment code length, and a maximum segment code length, a reserved segment quantity of each type of segments in segments of b−a+1 types of segment code lengths and a reserved code length corresponding to N, where a value of the minimum segment code length is 2\hat{ }^{a}, a value of the maximum segment code length is 2\hat{ }^{b}, the b−a+1 types of segment code lengths of the segments are 2\hat{ }^{c}, a, b, and c are positive integers, a<b, and a≤c≤b; orderly determining a segment quantity of each type of segments based on N, the reserved code length, a segment code length of each type of segments, and the reserved segment quantity of each type of segments and based on the segment code lengths from the largest to the smallest, where a sum of segment quantities of all types of segments is equal to S, N corresponds to S segments, and a segment code length of an i^{th} segment in the S segments is greater than or equal to a segment code length of an (i+1)^{th} segment in the S segments; determining a target information bit length of each segment based on the code rate and a segment code length of each segment in the S segments; and performing polar code encoding on the to-be-encoded information bits based on the target information bit length of each segment.

Through implementation of the method described in the first aspect, the segments of the b−a+1 types of segment code lengths are determined based on the minimum segment code length and the maximum segment code length, the value of the minimum segment code length is 2\hat{ }^{a}, and the value of the maximum segment code length is 2\hat{ }^{b}; and the code length N after encoding is divided into the S segments based on the minimum segment code length and the b−a+1 types of segment code lengths of the segments, the segment code length of the i^{th} segment in the S segments is greater than or equal to the segment code length of the (i+1)^{th} segment in the S segments, and the to-be-encoded information bits are allocated to the S segments for polar code encoding. Segment code lengths of segments of a packet trailer of a data packet after segmentation are in a decreasing trend, so that performance of a low-power communication system can be effectively improved when a low delay requirement is met.

In a possible implementation, the determining, based on a length of to-be-encoded information bits and a code rate, a code length N after encoding includes: determining a theoretical code length L based on the length K₀ of the to-be-encoded information bits and the code rate R, where a value of the theoretical code length is ceil(K₀/R), and ceil(x) represents rounding up X; and determining N based on the theoretical code length and the minimum segment code length 2\hat{ }^{a}, where a value of N is ceil(L/2\hat{ }^{a})*2\hat{ }^{a}.

In a possible implementation, the determining, based on N, a minimum segment code length, and a maximum segment code length, a reserved segment quantity of each type of segments in segments of b−a+1 types of segment code lengths and a reserved code length corresponding to N, where a value of the minimum segment code length is 2\hat{ }^{a}, a value of the maximum segment code length is 2\hat{ }^{b}, the b−a+1 types of segment code lengths of the segments are 2\hat{ }^{c}, a, b, and are positive integers, a<b, and a≤c≤b includes: determining the segments of the b−a+1 types of segment code lengths based on the minimum segment code length and the maximum segment code length, where the value of the minimum segment code length is 2\hat{ }^{a}, the value of the maximum segment code length is 2\hat{ }^{b}, the b−a+1 types of segment code lengths of the segments are 2\hat{ }^{c}, a, b, and c are positive integers, a<b, and a≤c≤b; orderly determining a reserved segment quantity of an i^{th} type of segments in the b−a+1 types of segments based on the b−a+1 types of segment code lengths of the segments from the smallest to the largest and based on N and the segment code length of each type of segments in the b−a+1 types of segments, where the reserved segment quantity of the i^{th} type of segments is greater than or equal to a reserved segment quantity of an (i+1)^{th} type of segments in the b−a+1 types of segments; and determining the reserved code length corresponding to N based on the reserved segment quantity of each type of segments and the segment code length of each type of segments.

In a possible implementation, the determining, based on N, a minimum segment code length, and a maximum segment code length, a reserved segment quantity of each type of segments in segments of b−a+1 types of segment code lengths and a reserved code length corresponding to N includes: if N<p*2\hat{ }^{b}, determining that a reserved segment quantity that corresponds to N and that is of segments whose segment code lengths are 2\hat{ }^{a} is

$$floor ( \frac{N}{{2}^{∧ a}} ) ,$$

and a reserved segment quantity that corresponds to N and that is of segments whose segment code lengths are 2\hat{ }j is 0, where a<j≤b and p≥2; if

$${p}^{*} {\sum }_{i = a}^{c} {2}^{∧ i} \leq N < p * {\sum }_{i = a}^{c + 1} {2}^{∧ i} ,$$

determining that a reserved segment quantity that corresponds to N and that is of segments whose segment code lengths are 2\hat{ }^{j} is 0, a reserved segment quantity that corresponds to N and that is of segments whose segment code lengths are 2\hat{ }^{c+1} is

$$floor ( \frac{N - p * {\sum }_{i = a}^{c} {2}^{∧ i}}{{2}^{∧ c + 1}} ) ,$$

and a reserved segment quantity that corresponds to N and that is of segments whose segment code lengths are 2\hat{ }^{v} is P, where a≤c≤b−1, a≤v≤c, and c+1<j≤b; or if

$$p * {\sum }_{i = a}^{b} {2}^{∧ i} \leq N ,$$

N determining that the reserved segment quantity of each type of segments is p; and determining the reserved code length Nᵣₑₛ based on the reserved segment quantity of each type of segments, where

$${N}_{res} = {\sum }_{c = a}^{b} {m}_{c , N} * {2}^{∧ c} ,$$

and m_{c,N} represents a reserved segment quantity that corresponds to N and that is of segments whose segment code lengths are 2\hat{ }^{c}. A value of P may be determined based on an actual case. Relative to a receiving rate, a lower reporting rate indicates a larger value of p.

When the reporting rate is very low, reporting of a last segment is not completed after a current segment is received. This causes a great impact on a delay of decoding and reporting. In this embodiment of this application, to effectively reduce an impact of reporting of the i^{th} segment on the delay of decoding and reporting, P segments are pre-reserved for segments of a same segment code length. Through implementation of the solution provided in this embodiment of this application, an adverse impact of a low reporting rate on the delay of decoding and reporting can be effectively reduced.

In a possible implementation, the determining, based on N, a minimum segment code length, and a maximum segment code length, a reserved segment quantity of each type of segments in segments of b−a+1 types of segment code lengths and a reserved code length corresponding to N includes: if N<2\hat{ }^{a}, determining that the reserved segment quantity of each type of segments is 0; if

$${{\sum }_{i = a}}^{c} {2}^{∧ i} \leq N < {\sum }_{i = a}^{c + 1} {2}^{∧ i} ,$$

determining that a reserved segment quantity of segments whose segment code lengths are 2\hat{ }^{j} is 0, and a reserved segment quantity of segments whose segment code lengths are 2\hat{ }^{v} is 1, where a≤c≤b−1, a≤v≤c, and c<j≤b; or if

$${\sum }_{i = a}^{b} 2 {\hat{}}^{i} \leq N ,$$

determining that the reserved segment quantity of each type of segments is 1; and determining the reserved code length Nᵣₑₛ based on the reserved segment quantity of each type of segments, where

$${N}_{res} = {\sum }_{c = a}^{b} {m}_{c , N} * 2 {\hat{}}^{c} ,$$

and m_{cN} represents a reserved segment quantity that corresponds to N and that is of segments whose segment code lengths are 2\hat{ }^{c}.

In this embodiment of this application, after the code length N is determined, a specific quantity of segments are pre-reserved for a segment type whose segment code length is small in the b−a+1 types of segments. This helps reduce the delay of decoding and reporting. The solution provided in this embodiment of this application is a special case in which the value of P is 1. In this embodiment of this application, there is no need to reserve a plurality of segments for segments of a same segment code length.

In a possible implementation, the orderly determining a segment quantity of each type of segments based on N, the reserved code length, a segment code length of each type of segments, and the reserved segment quantity of each type of segments and based on the segment code lengths from the largest to the smallest includes: orderly determining a remaining segment quantity of each type of segments based on N, the reserved code length, and the segment code length of each type of segments and based on the segment code lengths from the largest to the smallest, where the remaining segment quantity of each type of segments is a remaining segment quantity of each type of segments corresponding to a remaining code length that is obtained by subtracting the reserved code length from N; and determining the segment quantity of each type of segments based on the reserved segment quantity of each type of segments and the remaining segment quantity of each type of segments.

In this embodiment of this application, the remaining segment quantity of each type of segments is orderly determined based on the segment code lengths from the largest to the smallest, that is, the remaining code length is preferentially allocated to a segment type whose segment code length is large. This helps reduce a total segment quantity corresponding to N. A smaller segment quantity indicates better system performance.

In a possible implementation, the orderly determining a remaining segment quantity of each type of segments based on N, the reserved code length, and the segment code length of each type of segments and based on the segment code lengths from the largest to the smallest includes: if N<2\hat{ }^{a}, determining that a remaining segment quantity z_{c,N} that corresponds to N and that is of the segments whose segment code lengths are 2\hat{ }^{c} is 0, and a remaining segment quantity z_{a,N} that corresponds to N and that is of the segments whose segment code lengths are 2\hat{ }^{a} is 1, where a<c≤b; or if N≥2\hat{ }^{a}, orderly determining the remaining segment quantity of each type of segments based on the segment code lengths from the largest to the smallest, and determining that a remaining segment quantity z_{b,N} that corresponds to N and that is of segments whose segment code lengths are 2\hat{ }^{b} is

$$floor ( \frac{N - {N}_{r e s}}{2 {\hat{}}^{b}} ) ,$$

and a remaining segment quantity z_{c,N} that corresponds to N and that is of the segments whose segment code lengths are 2\hat{ }^{c} is

$$floor ( \frac{N - {N}_{r e s} - {\sum }_{e = c + 1}^{b} {𝓏}_{e , N} * 2 {\hat{}}^{e}}{2 {\hat{}}^{c}} ) ,$$

where a≤c<b, and floor(x) represents rounding down x.

In a possible implementation, the determining the segment quantity of each type of segments based on the reserved segment quantity of each type of segments and the remaining segment quantity of each type of segments includes: determining a segment quantity M_{c,N} that corresponds to N and that is of the segments whose segment code lengths are 2\hat{ }^{c}, where M_{c,N}=m_{c,N}+z_{c,N}, and a≤c≤b.

In this embodiment of this application, segment code lengths of the S segments are in a decreasing trend, so that performance of a low-power communication system can be effectively improved when a low delay requirement is met.

In a possible implementation, the determining a target information bit length of each segment based on the code rate and a segment code length of each segment in the S segments includes: determining that a target information bit length of a segment whose segment code length is 2\hat{ }^{c} in the S segments is ceil(2\hat{ }^{c}*R).

In this embodiment of this application, the target information bit length of each segment is determined based on the code rate and the segment code length of each segment. To ensure that the target information bit length of the segment is a positive integer, (2\hat{ }^{c}*R) is rounded up.

In a possible implementation, the determining a target information bit length of each segment based on the code rate and a segment code length of each segment in the S segments includes: if

$${\sum }_{c = a}^{b} {M}_{c , N} * ceil ( 2 {\hat{}}^{c} * R ) = {K}_{0} ,$$

determining that a target information bit length of a segment whose segment code length is 2\hat{ }^{c} is ceil(2\hat{ }^{c}*R), where a≤c≤b; or if

$${\sum }_{c = a}^{b} {M}_{c , N} * ceil ( 2 {\hat{}}^{c} * R ) = {K}_{0} ,$$

determining that a target information bit length of a segment whose segment code length is 2\hat{ }^{c} is ceil(2\hat{ }^{c}*R), target information bit lengths that correspond to N and that are of the first M_{a,N}−1 segments in M_{a,N} segments whose segment code lengths are 2\hat{ }^{a} are ceil(2\hat{ }^{a}*R), and a target information bit length of an (M_{a,N})^{th} segment in the M_{a,N} segments is

$${K}_{0} - {\sum }_{c = a + 1}^{b} {M}_{c , N} * ceil ( 2 {\hat{}}^{c} * R ) + ( {M}_{a , N} - 1 ) * ceil ( 2 {\hat{}}^{a} * R ) ,$$

where the (M_{a,N})^{th} segment is an S^{th} segment in the S segments, and a<c≤b.

In this embodiment of this application, to ensure that a sum of target information bit lengths of the S segments is equal to the length of the to-be-encoded information bits, a target information bit length of the S^{th} segment in the S segments can be adjusted.

In a possible implementation, the determining a target information bit length of each segment based on the code rate and a segment code length of each segment in the S segments includes: determining a reference information bit length of each segment; and determining the target information bit length of each segment based on the reference information bit length of each segment and the segment quantity of each type of segments.

In this embodiment of this application, the reference information bit length of each segment is determined first, and then the target information bit length of each segment is adjusted based on the reference information bit length and an actual requirement.

In a possible implementation, the determining a target information bit length of each segment based on the code rate and a segment code length of each segment in the S segments includes: if

$${\sum }_{c = a}^{b} {M}_{c , N} * ceil ( 2 {\hat{}}^{c} * R ) = {K}_{0} ,$$

determining that a reference information bit length that corresponds to N and that is of a segment whose segment code length is 2\hat{ }^{c} is ceil(2\hat{ }^{c}*R), where a≤c≤b; or if

$${\sum }_{c = a}^{b} {M}_{c , N} * ceil ( 2 {\hat{}}^{c} * R ) > {K}_{0} ,$$

determining that a reference information bit length that corresponds to N and that is of a segment whose segment code length is 2\hat{ }^{c} is ceil(2\hat{ }^{c}*R), reference information bit lengths of the first M_{a,N}−1 segments in M_{a,N} segments are ceil(2\hat{ }^{a}*R), and a reference information bit length of an (M_{a,N})^{th} segment in the M_{a,N} segments is

$${K}_{0} - {\sum }_{c = a + 1}^{b} {M}_{c , N} * ceil ( 2 {\hat{}}^{c} * R ) + ( {M}_{a , N} - 1 ) * ceil ( 2 {\hat{}}^{a} * R ) ,$$

where the (M_{a,N})^{th} segment is an S^{th} segment in the S segments, and a<c≤b; and determining the target information bit length of each segment based on the reference information bit length of each segment and the segment quantity of each type of segments.

In a possible implementation, the reference information bit length of the segment whose segment code length is 2\hat{ }^{c} in the S segments is ceil(2\hat{ }^{c}*R).

In a possible implementation, the determining the target information bit length of each segment based on the reference information bit length of each segment and the segment quantity of each type of segments includes: determining the target information bit length of each segment according to an allocation principle. The allocation principle is that on the basis of the reference information bit length of each segment, a first information bit length is totally added to f segments whose segment code lengths are the largest in the S segments, h segments whose segment code lengths are not the largest in the S segments are reduced by totally the first information bit length, a segment code rate of a (j+1)^{th} segment in the h segments is less than or equal to a segment code rate of a j^{th} segment in the h segments, a segment code length of the (j+1)^{th} segment is less than or equal to a segment code length of the j^{th} segment, and a sum of target information bit lengths of the S segments is K₀, where f and h are positive integers, and a segment code rate of a segment=a target information bit length of the segment/a segment code length of the segment.

In a possible implementation, the determining the target information bit length of each segment based on the reference information bit length of each segment and the segment quantity of each type of segments includes: determining a target information bit length of a first segment, where the target information bit length of the first segment is equal to a reference information bit length of the first segment plus a second information bit length, and the first segment is a segment whose segment code length is the largest in the S segments; and determining a target information bit length of a second segment, where the target information bit length of the second segment is equal to a reference information bit length of the second segment minus a third information bit length, and the second segment is a segment whose segment code length is not the largest in the S segments. In the S segments, h segments whose segment code lengths are not the largest are reduced by totally f times of the second information bit length, where a segment code rate of a (j+1)^{th} segment in the h segments is less than or equal to a segment code rate of a j^{th} segment in the h segments, a segment code length of the (j+1)^{th} segment is less than or equal to a segment code length of the j^{th} segment, a sum of target information bit lengths of the S segments is K₀, f is a segment quantity of segments whose segment code lengths are the largest in the S segments, and h is a positive integer greater than or equal to 0.

In this embodiment of this application, information bit lengths of the segments whose segment code lengths are not the largest are adjusted, so that a segment with a smaller segment code length in the segments whose segment code lengths are not the largest has a smaller segment code rate. This improves overall system performance, and can further reduce the delay of decoding and reporting.

In a possible implementation, the determining the target information bit length of each segment based on the reference information bit length of each segment and the segment quantity of each type of segments includes: if a segment code length of a segment whose segment code length is the largest in the S segments is 2\hat{ }^{a}, determining that a target information bit length of the segment whose segment code length is 2\hat{ }^{a} is equal to a reference information bit length of the segment whose segment code length is 2\hat{ }^{a}; or if a segment code length of a segment whose segment code length is the largest in the S segments 2\hat{ }^{r}, determining that a target information bit length of the segment whose segment code length is 2\hat{ }^{r} is a reference information bit length of the segment whose segment code length is 2\hat{ }^{r} plus

$${\sum }_{c = a}^{r - 1} {\partial }_{c} * {M}_{c , N} ,$$

and a target information bit length of a segment whose segment code length is 2\hat{ }^{c} is a reference information bit length of the segment whose segment code length is 2\hat{ }^{c} minus ∂_{c}*M_{r,N}, where a≤c<r, ∂_{c} is a proportion parameter, and ∂_{c} is a positive integer.

In a possible implementation, 0<∂_{c+1}≤2∂_{c}.

In this embodiment of this application, 0≤∂_{c+1}2∂_{c}, so that a segment with a smaller segment code length in the segments whose segment code lengths are not the largest has a smaller segment code rate.

In a possible implementation, if M_{b,N}>T, and T is a positive integer, the determining the target information bit length of each segment based on the reference information bit length of each segment and the segment quantity of each type of segments includes: determining that target information bit lengths of the first T segments in M_{b,N} segments whose segment code lengths are 2\hat{ }^{b} are a reference information bit length of the segment whose segment code length is 2\hat{ }^{b} plus

$${\sum }_{c = a}^{b - 1} {\partial }_{c} * {M}_{c , N} ,$$

target information bit lengths of the last M_{b,N}−T segments in the M_{b,N} segments are equal to the reference information bit length of the segment whose segment code length is 2\hat{ }^{b}, and a target information bit length of a segment whose segment code length is 2\hat{ }^{c} is a reference information bit length of the segment whose segment code length is 2\hat{ }^{c} minus ∂_{c}*T, where a≤c<b, and ∂_{c} is a positive integer.

In this embodiment of this application, the following problems caused by a large segment quantity M_{b,N} of segments whose segment code lengths are the largest can be resolved: An information bit length added for the segments whose segment code lengths are the largest in the S segments is excessively large. In addition, the information bit length reduced for the segments whose segment code lengths are not the largest in the S segments is excessively large.

In a possible implementation, the performing polar code encoding on the to-be-encoded information bits based on the target information bit length of each segment includes: orderly allocating the to-be-encoded information bits to the S segments based on the target information bit length of each segment, and performing polar code encoding on information bits of each segment.

In a possible implementation, the performing polar code encoding on the to-be-encoded information bits based on the target information bit length of each segment includes: if

$${\sum }_{c = a}^{b} {M}_{c , N} * ceil ( 2 {\hat{}}^{c} * R ) = {K}_{0} ,$$

, orderly allocating the to-be-encoded information bits to the S segments based on the target information bit length of each segment, and performing polar code encoding on information bits of each segment; or if

$${\sum }_{c = a}^{b} {M}_{c , N} * ceil ( 2 {\hat{}}^{c} * R ) > {K}_{0} ,$$

performing zero-padding on to-be-encoded information bits whose information bit length is K₀, where the information bit length of the to-be-encoded information bits after zero-padding is

$${\sum }_{c = a}^{b} {M}_{c , N} * ceil ( 2 {\hat{}}^{c} * R ) ,$$

orderly allocating the to-be-encoded information bits after zero-padding to the S segments based on the target information bit length of each segment, and performing polar code encoding on information bits of each segment.

In this embodiment of this application, a round up operation is used in a process of determining the target information bit length of each segment, so that the sum of the target information bit lengths of the S segments corresponding to N is greater than the length of the to-be-encoded information bits. Through a zero-padding operation, the length of the to-be-encoded information bits after zero-padding can be equal to the sum of the target information bit lengths of the S segments. This helps subsequently perform polar code encoding on each segment.

According to a second aspect, an embodiment of this application provides a terminal device. The terminal device may include a plurality of functional modules or units, configured to correspondingly perform the polar code segment encoding method provided in the first aspect.

For example, the terminal device may include a code length determining unit, a reservation unit, a segment quantity determining unit, an information bit length determining unit, and an encoding unit.

The code length determining unit is configured to determine, based on a length of to-be-encoded information bits and a code rate, a code length N after encoding, where N is a positive integer.

The reservation unit is configured to determine, based on N, a minimum segment code length, and a maximum segment code length, a reserved segment quantity of each type of segments in segments of b−a+1 types of segment code lengths and a reserved code length corresponding to N, where a value of the minimum segment code length is 2\hat{ }^{a}, a value of the maximum segment code length is 2\hat{ }^{b}, the b−a+1 types of segment code lengths of the segments are 2\hat{ }^{c}, a, b, and are positive integers, a<b, and a≤c≤b.

The segment quantity determining unit is configured to orderly determine a segment quantity of each type of segments based on N, the reserved code length, a segment code length of each type of segments, and the reserved segment quantity of each type of segments and based on the segment code lengths from the largest to the smallest, where a sum of segment quantities of all types of segments is equal to S, N corresponds to S segments, and a segment code length of an i^{th} segment in the S segments is greater than or equal to a segment code length of an (i+1)^{th} segment in the S segments.

The information bit length determining unit is configured to determine a target information bit length of each segment based on the code rate and a segment code length of each segment in the S segments.

The encoding unit is configured to perform polar code encoding on the to-be-encoded information bits based on the target information bit length of each segment.

In a possible implementation, the code length determining unit is specifically configured to: determine a theoretical code length L based on the length K₀ of the to-be-encoded information bits and the code rate R, where a value of the theoretical code length is ceil(K₀/R), and ceil(x) represents rounding up X; and determine N based on the theoretical code length and the minimum segment code length 2\hat{ }^{a}, where a value of N is ceil(L/2\hat{ }^{a})*2\hat{ }^{a}.

In a possible implementation, the reservation unit is specifically configured to: determine the segments of the b−a+1 types of segment code lengths based on the minimum segment code length and the maximum segment code length, where the value of the minimum segment code length is 2\hat{ }^{a}, the value of the maximum segment code length is 2\hat{ }^{b}, the b−a+1 types of segment code lengths of the segments are 2\hat{ }^{c}, a, b, and c are positive integers, a<b, and a≤c≤b; orderly determine a reserved segment quantity of an i^{th} type of segments in the b−a+1 types of segments based on the b−a+1 types of segment code lengths of the segments from the smallest to the largest and based on N and the segment code length of each type of segments in the b−a+1 types of segments, where the reserved segment quantity of the i^{th} type of segments is greater than or equal to a reserved segment quantity of an (i+1)^{th} type of segments in the b−a+1 types of segments; and determine the reserved code length corresponding to N based on the reserved segment quantity of each type of segments and the segment code length of each type of segments.

In a possible implementation, the reservation unit is specifically configured to: if N<p*2\hat{ }^{a}, determine that a reserved segment quantity that corresponds to N and that is of segments whose segment code lengths are 2\hat{ }^{a} is

$$floor ( \frac{N}{{2}^{∧ a}} ) ,$$

and a reserved segment quantity that corresponds to N and that is of segments whose segment code lengths are 2\hat{ }^{j} is 0, where a<j≤b, and p≥2; if

$$p * {{\sum }_{i = a}}^{c} {2}^{∧ i} \leq N < p * {\sum }_{i = a}^{c + 1} {2}^{∧ i} ,$$

determine that a reserved segment quantity that corresponds to N and that is of segments whose segment code lengths are 2\hat{ }^{j} is 0, a reserved segment quantity that corresponds to N and that is of segments whose segment code lengths are 2\hat{ }^{c+1} is

$$floor ( \frac{N - p * {\sum }_{i = a}^{c} {2}^{∧ i}}{{2}^{∧ c + 1}} ) ,$$

and a reserved segment quantity that corresponds to N and that is of segments whose segment code lengths are 2\hat{ }^{v} is P, where a≤c≤b−1, a≤v≤c, and c+1<j≤b; or if

$$p * {\sum }_{i = a}^{b} {2}^{∧ i} \leq N ,$$

determine that the reserved segment quantity of each type of segments is p; and determine the reserved code length Nᵣₑₛ based on the reserved segment quantity of each type of segments, where

$${N}_{res} = {\sum }_{c = a}^{b} {m}_{c , N} * {2}^{∧ c} ,$$

and m_{c,N} represents a reserved segment quantity that corresponds to N and that is of segments whose segment code lengths are 2\hat{ }^{c}.

In a possible implementation, the reservation unit is specifically configured to: if N<2\hat{ }^{c}, determine that the reserved segment quantity of each type of segments is 0; if

$${{\sum }_{i = a}}^{c} {2}^{∧ i} \leq N < {\sum }_{i = a}^{c + 1} {2}^{∧ i} ,$$

determine that a reserved segment quantity of segments whose segment code lengths are 2\hat{ }^{j} is 0, and a reserved segment quantity of segments whose segment code lengths are 2\hat{ }^{v} is 1, where a≤c≤b−1, a≤v≤c and c<j≤b; or if

$${\sum }_{i = a}^{b} {2}^{∧ i} \leq N ,$$

determine that the reserved segment quantity of each type of segments is 1; and determine the reserved code length Nᵣₑₛ based on the reserved segment quantity of each type of segments, where

$${N}_{res} = {\sum }_{c = a}^{b} {m}_{c , N} * {2}^{∧ c} ,$$

and m_{c,N} represents a reserved segment quantity that corresponds to N and that is of segments whose segment code lengths are 2\hat{ }^{c}.

In a possible implementation, the segment quantity determining unit includes a remaining segment quantity determining unit and a segment quantity determining subunit.

The remaining segment quantity determining unit is configured to orderly determine a remaining segment quantity of each type of segments based on N, the reserved code length, and the segment code length of each type of segments and based on the segment code lengths from the largest to the smallest, where the remaining segment quantity of each type of segments is a remaining segment quantity of each type of segments corresponding to a remaining code length that is obtained by subtracting the reserved code length from N.

The segment quantity determining subunit is configured to determine the segment quantity of each type of segments based on the reserved segment quantity of each type of segments and the remaining segment quantity of each type of segments.

In a possible implementation, the remaining segment quantity determining unit is specifically configured to: if N<2\hat{ }^{a}, determine that a remaining segment quantity z_{c,N} that corresponds to N and that is of the segments whose segment code lengths are 2\hat{ }^{c} is 0, and a remaining segment quantity z_{a,N} that corresponds to N and that is of the segments whose segment code lengths are 2\hat{ }^{a} is 1, where a<c≤b; or if N≥2\hat{ }^{a}, orderly determine the remaining segment quantity of each type of segments based on the segment code lengths from the largest to the smallest, and determine that a remaining segment quantity z_{b,N} that corresponds to N and that is of segments whose segment code lengths are 2\hat{ }^{b} is

$$floor ( \frac{N - {N}_{res}}{{2}^{∧ b}} ) ,$$

and a remaining segment quantity z_{c,N} that corresponds to N and that is of the segments whose segment code lengths are 2\hat{ }^{c} is

$$floor ( \frac{N - {N}_{r e s} - {\sum }_{e = c + 1}^{b} {𝓏}_{e , N} * {2}^{∧ e}}{{2}^{∧ c}} ) ,$$

where a≤c<b, and floor(x) represents rounding down x.

In a possible implementation, the segment quantity determining subunit is specifically configured to: determine a segment quantity M_{c,N} that corresponds to N and that is of the segments whose segment code lengths are 2\hat{ }^{c}, where M_{c,N}=m_{c,N}=z_{c,N}, and a≤c≤b.

In a possible implementation, the information bit length determining unit is specifically configured to: determine that a target information bit length of a segment whose segment code length is 2\hat{ }^{c} in the S segments is ceil(2\hat{ }^{c}*R).

In a possible implementation, the information bit length determining unit is specifically configured to: if

$${\sum }_{c = a}^{b} {M}_{c , N} * ceil ( {2}^{∧ c} * R ) = {K}_{0} ,$$

determine that a target information bit length of a segment whose segment code length is 2\hat{ }^{c} is ceil(2\hat{ }^{c}*R), where a≤c≤b; or if

$${\sum }_{c = a}^{b} {M}_{c , N} * ceil ( {2}^{∧ c} * R ) > {K}_{0} ,$$

determine that a target information bit length of a segment whose segment code length is 2\hat{ }^{c} is ceil(2\hat{ }^{c}*R), target information bit lengths that correspond to N and that are of the first M_{a,N}−1 segments in M_{a,N} segments whose segment code lengths are 2\hat{ }^{a} are ceil(2\hat{ }^{a}*R), and a target information bit length of an (M_{a,N})^{th} segment in the M_{a,N} segments is

$${K}_{0} - {\sum }_{c = a + 1}^{b} {M}_{c , N} * ceil ( {2}^{∧ c} * R ) + ( {M}_{a , N} - 1 ) * ceil ( {2}^{∧ a} * R ) ,$$

where the (M_{a,N})^{th} segment is an S^{th} segment in the S segments, and a<c≤b.

In a possible implementation, the information bit length determining unit includes a reference information bit length determining unit and a target information bit length determining unit.

The reference information bit length determining unit is configured to determine the reference information bit length of each segment.

The target information bit length determining unit is configured to determine the target information bit length of each segment based on the reference information bit length of each segment and the segment quantity of each type of segments.

In a possible implementation, the reference information bit length determining unit is specifically configured to: if

$${\sum }_{c = a}^{b} {M}_{c , N} * ceil ( {2}^{∧ c} * R ) = {K}_{0} ,$$

determine that a reference information bit length that corresponds to N and that is of a segment whose segment code length is 2\hat{ }^{c} is ceil(2\hat{ }^{c}*R), where a≤c≤b; or if

$${\sum }_{c = a}^{b} {M}_{c , N} * ceil ( {2}^{∧ c} * R ) > {K}_{0} ,$$

determine that a reference information bit length that corresponds to N and that is of a segment whose segment code length is 2\hat{ }^{c} is ceil(2\hat{ }^{c}*R), reference information bit lengths of the first M_{a,N}−1 segments in M_{a,N} segments are ceil(2\hat{ }^{c}*R), and a reference information bit length of an (M_{a,N})^{th} segment in the M_{a,N} segments is

$${K}_{0} - {\sum }_{c = a + 1}^{b} {M}_{c , N} * ceil ( 2 {\hat{}}^{c} * R ) + ( {M}_{a , N} - 1 ) * ceil ( 2 {\hat{}}^{a} * R ) ,$$

where the (M_{a,N})^{th} segment is an S^{th} segment in the S segments, and a<c≤b.

In a possible implementation, the reference information bit length of the segment whose segment code length is 2\hat{ }^{e} in the S segments is ceil(2\hat{ }^{c}*R).

In a possible implementation, the target information bit length determining unit is specifically configured to determine the target information bit length of each segment according to an allocation principle. The allocation principle is that on the basis of the reference information bit length of each segment, a first information bit length is totally added to f segments whose segment code lengths are the largest in the S segments, h segments whose segment code lengths are not the largest in the S segments are reduced by totally the first information bit length, a segment code rate of a (j+1)^{th} segment in the h segments is less than or equal to a segment code rate of a j^{th} segment in the h segments, a segment code length of the (j+1)^{th} segment is less than or equal to a segment code length of the j^{th} segment, and a sum of target information bit lengths of the S segments is K₀, where f and h are positive integers.

In a possible implementation, the target information bit length determining unit is specifically configured to: determine a target information bit length of a first segment, where the target information bit length of the first segment is equal to a reference information bit length of the first segment plus a second information bit length, and the first segment is a segment whose segment code length is the largest in the S segments; and determine a target information bit length of a second segment, where the target information bit length of the second segment is equal to a reference information bit length of the second segment minus a third information bit length, and the second segment is a segment whose segment code length is not the largest in the S segments. In the S segments, h segments whose segment code lengths are not the largest are reduced by totally f times of the second information bit length, where a segment code rate of a (j+1)^{th} segment in the h segments is less than or equal to a segment code rate of a j^{th} segment in the h segments, a segment code length of the (j+1)^{th} segment is less than or equal to a segment code length of the j^{th} segment, a sum of target information bit lengths of the S segments is K₀, f is a segment quantity of segments whose segment code lengths are the largest in the S segments, and h is a positive integer greater than or equal to 0.

In a possible implementation, the target information bit length determining unit is specifically configured to: if a segment code length of a segment whose segment code length is the largest in the S segments is 2\hat{ }^{a}, determine that a target information bit length of the segment whose segment code length is 2\hat{ }^{a} is equal to a reference information bit length of the segment whose segment code length is 2\hat{ }^{a}; or if a segment code length of a segment whose segment code length is the largest in the S segments is 2\hat{ }^{r}, determine that a target information bit length of the segment whose segment code length is 2\hat{ }^{r} is a reference information bit length of the segment whose segment code length is 2\hat{ }^{r} plus

$${\sum }_{c = a}^{r - 1} {\partial }_{c} * {M}_{c , N} ,$$

and a target information bit length of a segment whose segment code length is 2\hat{ }^{c} is a reference information bit length of the segment whose segment code length is 2\hat{ }^{c} minus ∂_{c}*M_{r,N}, where a≤c<r, ∂_{c} is a proportion parameter, and ∂_{c} is a positive integer.

In a possible implementation, 0<∂_{c+1}≥2∂_{c}.

In a possible implementation, if M_{b,N}>T, and T is a positive integer, the target information bit length determining unit is specifically configured to: determine that target information bit lengths of the first T segments in M_{b,N} segments whose segment code lengths are 2\hat{ }^{b} are a reference information bit length of the segment whose segment code length is 2\hat{ }^{b} plus

$${\sum }_{c = a}^{b - 1} {\partial }_{c} * {M}_{c , N} ,$$

target information bit lengths of the last M_{b,N}−T segments in the M_{b,N} segments are equal to the reference information bit length of the segment whose segment code length is 2\hat{ }^{b}, and a target information bit length of a segment whose segment code length is 2\hat{ }^{c} is a reference information bit length of the segment whose segment code length is 2\hat{ }^{c} minus ∂_{c}*T, where a≤c<b, and ∂_{c} is a positive integer.

In a possible implementation, 0<∂_{c+1}≤2∂_{c}.

In a possible implementation, the encoding unit is specifically configured to: orderly allocate the to-be-encoded information bits to the S segments based on the target information bit length of each segment, and perform polar code encoding on information bits of each segment.

In a possible implementation, the encoding unit is specifically configured to: if

$${\sum }_{c = a}^{b} {M}_{c , N} * ceil ( 2 {\hat{}}^{c} * R ) = {K}_{0} ,$$

orderly allocate the to-be-encoded information bits to the S segments based on the target information bit length of each segment, and perform polar code encoding on information bits of each segment; or if

$${\sum }_{c = a}^{b} {M}_{c , N} * ceil ( 2 {\hat{}}^{c} * R ) > {K}_{0} ,$$

perform zero-padding on to-be-encoded information bits whose information bit length is K₀, where the information bit length of the to-be-encoded information bits after zero-padding is

$${\sum }_{c = a}^{b} {M}_{c , N} * ceil ( 2 {\hat{}}^{c} * R ) ,$$

orderly allocate the to-be-encoded information bits after zero-padding to the S segments based on the target information bit length of each segment, and perform polar code encoding on information bits of each segment.

According to a third aspect, an embodiment of this application provides a communication device, configured to perform the polar code segment encoding method provided in the first aspect. The network device may include a memory, a processor, a transmitter, and a receiver, where the transmitter and the receiver are configured to communicate with another communication device. The memory is configured to store implementation code of the polar code segment encoding method provided in the first aspect, and the processor is configured to execute program code stored in the memory, that is, perform the polar code segment encoding method provided in the first aspect.

According to a fourth aspect, this application provides a communication chip. The communication chip may include a processor and one or more interfaces coupled to the processor. The processor may be configured to invoke some or all of implementation programs of the polar code segment encoding method provided in the first aspect from a memory, and execute instructions included in some or all of the implementation programs. The interface may be configured to output a data processing result of the processor.

According to a fifth aspect, an embodiment of this application provides a computer-readable storage medium, where the readable storage medium stores program instructions, and when the program instructions are run on a processor, the processor is enabled to perform the polar code segment encoding method described in the third aspect.

According to a sixth aspect, an embodiment of this application provides a computer program product including instructions, and when the computer program product is run on a processor, the processor is enabled to perform the polar code segment encoding method described in the first aspect.

### BRIEF DESCRIPTION OF DRAWINGS

FIG. 1 is a schematic diagram of a system architecture of a Bluetooth communication system according to an embodiment of this application;

FIG. 2 is a schematic diagram of data transmission according to an embodiment of this application;

FIG. 3 is a schematic diagram of a delay of decoding and reporting according to an embodiment of this application;

FIG. 4 is a schematic diagram of another delay of decoding and reporting according to an embodiment of this application;

FIG. 5 is a schematic flowchart of polar code segment encoding according to an embodiment of this application;

FIG. 6 is a schematic diagram of another delay of decoding and reporting according to an embodiment of this application;

FIG. 7 is a schematic diagram of a principle of polar code segment encoding and segment decoding according to an embodiment of this application;

FIG. 8 is a schematic diagram of a structure of a terminal device according to an embodiment of this application; and

FIG. 9 is a schematic diagram of a structure of a polar code segment encoding apparatus according to an embodiment of this application.

### DESCRIPTION OF EMBODIMENTS

The following clearly describes technical solutions in embodiments of this application in detail with reference to accompanying drawings. In descriptions of the embodiments of this application, unless otherwise stated, “/” indicates “or”. For example, A/B may indicate A or B. The term “and/or” in this specification merely describes an association relationship for describing associated objects, and indicates that three relationships may exist. For example, A and/or B may indicate the following three cases: Only A exists, both A and B exist, and only B exists. In addition, in the descriptions of the embodiments of this application, “a plurality of” means two or more.

The terms “first” and “second” mentioned below are merely intended for description, and shall not be understood as an indication or implication of relative importance or implicit indication of a quantity of indicated technical features. Therefore, a feature limited by “first” or “second” may explicitly or implicitly include one or more features. In the descriptions of the embodiments of this application, unless otherwise specified, “a plurality of” means two or more.

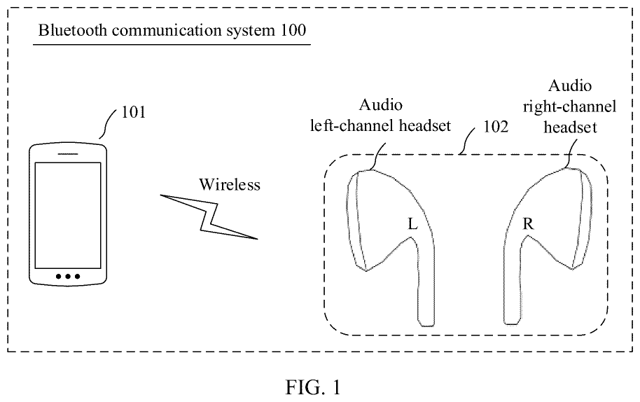

FIG. 1 shows a network architecture of a Bluetooth communication system 100 according to an embodiment of this application. As shown in FIG. 1, the communication system 100 may include a terminal device 101 and a Bluetooth headset 102.

The Bluetooth communication system 100 is based on a Bluetooth technology. The Bluetooth technology is an open global specification for wireless data and voice communication. The Bluetooth technology is based on a low-cost short-range wireless connection, and is a special short-range wireless connection technology for establishing communication environments for fixed and mobile devices. The Bluetooth technology enables some portable mobile devices and computer devices today to connect to the Internet without requiring cables, and to access the Internet wirelessly. The Bluetooth technology replaces an infrared technology, to be applied to computers and mobile communication products with advantages of low costs, low power consumption, a short range, a high frequency (a frequency hopping technology), and high confidentiality.

The terminal device 101 may be fixed, or may be mobile. In some embodiments of this application, the terminal device 101 may be implemented as a mobile device, user equipment (UE), a terminal, a UE unit, a UE station, a mobile device, or the like. This is not limited in this embodiment of this application.

The Bluetooth headset 102 may be fixed, or may be mobile. A distance between the Bluetooth headset 102 and the terminal device 101 falls within a preset range. As shown in FIG. 1, the Bluetooth headset may be divided into an audio-left channel headset and an audio-right channel headset. One of the audio left-channel headset and the audio-right channel headset is a primary headset of the Bluetooth headset 102, and the other is a secondary headset of the Bluetooth headset 102.

The Bluetooth communication system 100 is very sensitive to a delay. After receiving data, the Bluetooth headset needs to process the data in a very short time and reply with an acknowledgment message. Currently, interval duration from a time point at which the terminal device 101 completes sending the data to a time point the terminal device 101 receives an ACK of the primary headset is 189 μs.

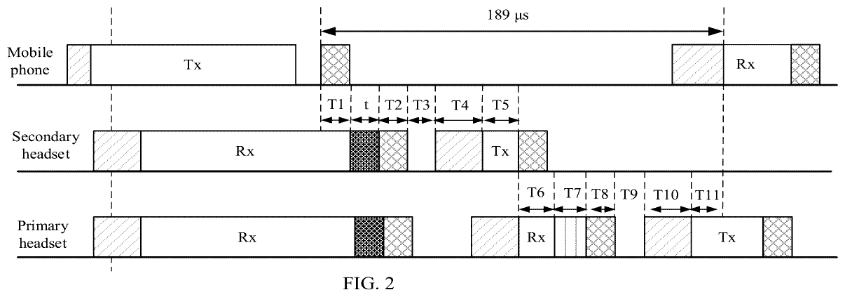

FIG. 2 is a schematic diagram of data transmission according to an embodiment of this application, where T1 represents a receiving delay of the secondary headset; T2 represents duration in which the secondary headset receives a power-off procedure; T3 represents a processing delay of a media access control (MAC) layer; T4 represents duration in which the secondary headset receives a power-on procedure; T5 represents duration in which the secondary headset sends a notification message to the primary headset, and the notification message is used to notify that the primary headset has received data; T6 represents a synchronization delay and a receiving delay of the primary headset; T7 represents waiting duration of a receiving window; T8 represents duration in which the primary headset receives a power-off procedure; T9 represents a processing delay of a MAC layer; T10 represents duration in which the primary headset sends a power-on procedure; T11 represents a receiving delay of a mobile phone; and t represents duration in which the secondary headset performs decoding and reporting. For example, duration of T1 is about 10 μs, duration of T2 is 10 μs, duration of T3 is about 10 μs, duration of T4 is 35 μs, duration of T5 is 40 s, duration of T6 is 15 μs, duration of T7 is 6 μs, duration of T8 is 10 μs, duration of T9 is 4 μs, duration of T10 is 25 μs, and duration of T11 is 5 μs. As shown in FIG. 2, after receiving all information sent by the mobile phone, the secondary headset has a t μs time margin to complete decoding and data reporting, where t=189−T1−T2−T3−T4−T5−T6−T7−T8−T9−T10−T11, and t=15 μs.

For a system that requires low power consumption, for example, a Bluetooth system, power of information reporting is usually limited. Consequently, a reporting rate of reporting information bits to the MAC layer is limited to the power of information reporting. For ease of description, in this application, duration from a time point at which all data sent by the terminal device is received by the primary headset and/or the secondary headset to a time point at which the primary headset and/or the secondary headset performs decoding and reporting is referred to as a delay of decoding and reporting, and the delay of decoding and reporting needs to be less than or equal to t. If the delay of decoding and reporting exceeds t, the mobile phone cannot accurately receive the acknowledgment message fed back by the primary headset.

An existing Bluetooth system usually uses an encoding manner in which no channel code or convolutional code is used. Although the foregoing two encoding manners may meet a delay requirement, performance of the Bluetooth system needs to be improved. In this application, performance of the entire system is improved by using polar code.

Polar code is the first encoding manner that is theoretically proven to reach a Shannon capacity, and has characteristics of high performance and low encoding and decoding complexity. In different code lengths, especially for code based on a finite field, performance of the polar code is much better than Turbo code and LDPC code. Currently, the polar code has become an encoding manner for new radio (NR) control information of the 3rd generation partnership project protocol (3GPP).

The polar code is linear block code, a generation matrix of the polar code is F_{N}, and an encoding process of the polar code is x₁^{N}=u₁^{N}F_{N}. u₁^{N}=(u₁,u₂, . . . , u_{N}) is a binary row vector with a length N (namely, a code length). F_{N} is a matrix of N×N, and F_{N}=F₂^{⊗(log}^{₂}^{(N))}. Herein,

$${F}_{2} = [ \begin{matrix}1 & 0 \\ 1 & 1\end{matrix} ] ,$$

and F₂^{⊗(log}^{₂}^{(N))} is defined as a Kronecker product of log₂ N matrices F₂.

In the encoding process of the polar code, some bits in u₁^{N} are used to carry information, and are referred to as information bits. A set of indexes of these bits is recorded as I. The other bits are set to be fixed values pre-appointed by a transmit end and a receive end, and are referred to as fixed bits. A set of indexes of these bits is represented by a complementary set I^{c} of I. The fixed bits are usually set to 0. However, the fixed bits may be randomly set provided that the transmit end and the receive end reach an agreement in advance.

For the polar code, encoding and decoding are performed based on a segment code length (a power of 2). A longer segment code length indicates a stronger error correcting capability and greater complexity. Therefore, an appropriate segment code length is usually selected after performance and complexity are weighed. The polar code is linear block code. If a transmitted data packet is large, which far exceeds a maximum segment code length set by the polar code, in this case, segment processing may be performed on transmitted data.

There are two existing polar code segmentation manners in 5G. In a first segmentation manner, an information bit sequence is evenly divided into two segments. If an information bit length of the information bit sequence cannot be divided by 2, zero-padding is performed at a front end of a first segment in the two segments. When polar code segment encoding is performed in the first segmentation manner, rate matching needs to be performed on all segments, that is, a segment code length of each segment obtained after polar code encoding is converted to an actually required length in a manner of puncturing, shortening, or repetition. It may be understood that the actually required length meets the power of 2.

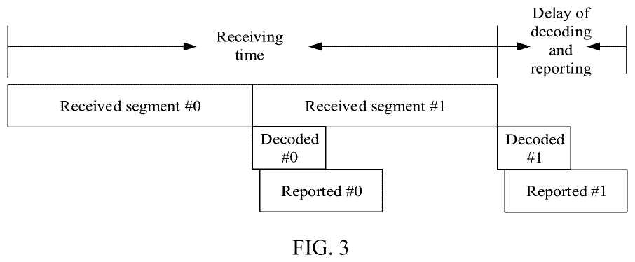

In the first segmentation manner, rate matching needs to be performed, which increases implementation complexity and is not applicable to a low-power system. In addition, the first segmentation manner may not meet a delay requirement of decoding and reporting. For example, FIG. 3 is a schematic diagram of a delay of decoding and reporting of a first segmentation manner according to an embodiment of this application. For example, in the Bluetooth communication system, a Bluetooth bandwidth is less than or equal to 3 Mb/s (megabit per second), a reporting bandwidth is equal to 8 Mb/s, and a code rate is equal to 2/3. If an information bit length K₁ of a second segment (segment #1) in the two segments is 683, and a segment code length N, is 1024, a reporting time of the second segment is K₁/8 s (microsecond), namely, 83.375 μs, which exceeds the 15 μs delay limit of decoding and reporting.

In a second segmentation manner, an information bit sequence is divided into n segments based on a maximum segment code length, and code rates corresponding to the n segments are equal. Segment code lengths of the first n−1 segments in the n segments are the maximum segment code length, and information bit lengths of the first n−1 segments may be determined based on the maximum segment code length and the code rates; an information bit length of the last segment in the n segments may be determined; and then a segment code length of the last segment may be determined based on the code rate and the information bit length of the last segment.

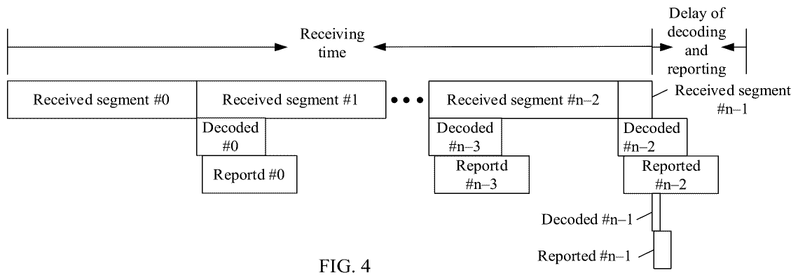

In the second segmentation manner, rate matching does not need to be performed. Compared with the first segmentation manner, implementation complexity is reduced. However, the second segmentation manner may alternatively not meet the delay limit of decoding and reporting. For example, FIG. 4 is a schematic diagram of a delay of decoding and reporting of a second segmentation manner according to an embodiment of this application. For example, in the Bluetooth communication system, a Bluetooth bandwidth is less than or equal to 3 Mb/s, a reporting bandwidth is equal to 8 Mb/s, and a code rate is equal to 2/3. If a segment code length N₂ of an (n−1)^{th} segment (segment #n−2) in the n segments is 1024, and an information bit length K₂ is 683, a reporting time of the (n−1)^{th} segment is 83.375 μs. If an information bit length K₃ of an n^{th} segment (segment #n−1) in the n segments is 10, and a segment code length N₃ is 16, a receiving time of the n^{th} segment is 16/3 Mb/s, namely, 5.3 μs, and a delay of decoding and reporting after data of the n^{th} segment is received is 85.375 μs-5.3 μs, namely, 80.075 μs, which exceeds the 15 μs delay limit of decoding and reporting. In the second segmentation manner, if the information bit length of the n^{th} segment is small, all of receiving duration, decoding duration, and reporting duration are relatively small. In this case, the delay of decoding and reporting is limited to reporting duration of the (n−1)^{th} segment.

In this application, it is hoped that the performance of the entire system is improved by using the polar code. In addition, a new segmentation method is proposed by using a characteristic that the polar code is linear block code, to meet a delay limit on decoding and reporting of a low-power system in this application.

An embodiment of this application provides a polar code segment encoding method.

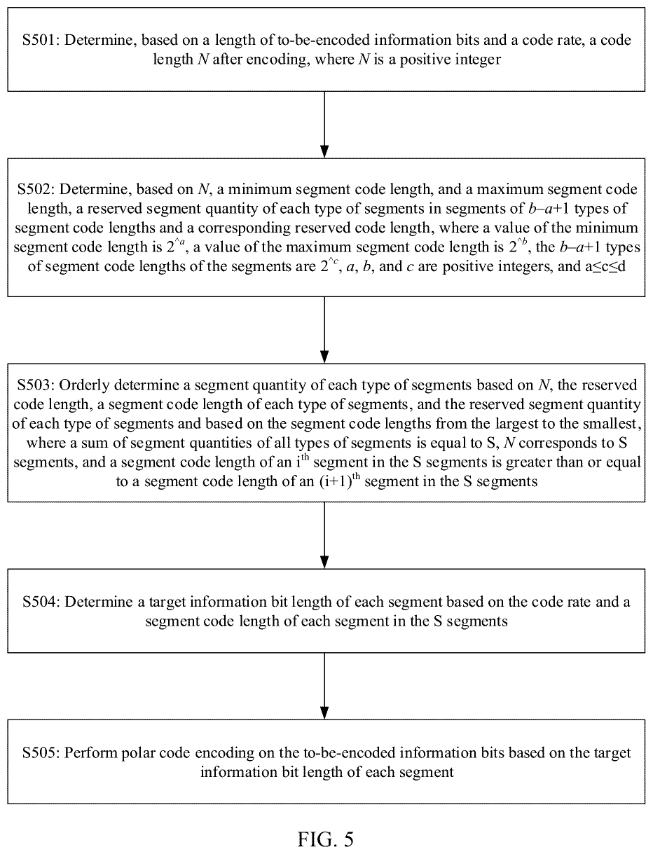

FIG. 5 is a schematic flowchart of a polar code segment encoding method according to an embodiment of this application. As shown in FIG. 5, the polar code segment encoding method provided in this embodiment of this application includes but is not limited to steps S501 to S505. The following further describes possible implementations of the method embodiment.

S501: Determine, based on a length of to-be-encoded information bits and a code rate, a code length N after encoding, where N is a positive integer.

Optionally, based on the foregoing analysis, the determining, based on a length of to-be-encoded information bits and a code rate, a code length N after encoding includes: determining a theoretical code length L based on the length K₀ of the to-be-encoded information bits and the code rate R, where a value of the theoretical code length is ceil(K₀/R), and ceil(x) represents rounding up X; and determining N based on the theoretical code length and the minimum segment code length 2\hat{ }^{a}, where a value of N is ceil(L/2\hat{ }^{a})*2\hat{ }^{a}. According to the determining manner of the code length N, it is ensured that an actual code length N after encoding is an integer multiple of the minimum segment code length.

It should be noted that in this embodiment of this application, it is proposed that segment code lengths of all segments corresponding to the code length N need to be equal to a power of 2, and a segment code length of each segment is greater than or equal to a preset minimum segment code length. It may be understood that in the foregoing case, a sum (that is, the actual code length after encoding) of the segment code lengths of all the segments is an integer multiple of the minimum segment code length. In the determining manner of the code length N, rate matching does not need to be performed, and implementation complexity is not increased. Therefore, the determining manner is applicable to a low-power system.

S502: Determine, based on N, a minimum segment code length, and a maximum segment code length, a reserved segment quantity of each type of segments in segments of b−a+1 types of segment code lengths and a reserved code length corresponding to N, where a value of the minimum segment code length is 2\hat{ }^{a}, a value of the maximum segment code length is 2\hat{ }^{b}, the b−a+1 types of segment code lengths of the segments are 2\hat{ }^{c}, a, b, and c are positive integers, a<b, and a≤c≤b.

Optionally, if the value of the minimum segment code length is 2\hat{ }^{a}, and the value of the maximum segment code length is 2\hat{ }^{b}, the segments of the b−a+1 types of segment code lengths may be determined based on the minimum segment code length and the maximum segment code length, the b−a+1 types of segment code lengths of the segments are 2\hat{ }^{c}, a, b, and c are positive integers, a<b, and a≤c≤b.

In this embodiment of this application, the actual code length N is divided into S segments. The S segments include one or more types of segments in the b−a+1 types of segments that correspond to the b−a+1 types of segment code lengths. A delay of decoding and reporting is mainly limited to the last y segments of the S segments, where S and y are positive integers, and y is less than or equal to S.

It may be understood that in this embodiment of this application, a segment code length of each type of segments is equal to the power of 2. Therefore, implementation complexity can be relatively reduced in the solution provided in this embodiment of this application.

Optionally, segment code lengths of the last y segments of the S segments are less than segment code lengths of the first S-y segments of the S segments.

It may be understood that a smaller information bit length of a segment (in a same code rate, a smaller segment code length of the segment) indicates shorter duration of decoding and reporting. That the segment code lengths of the last y segments are less than the segment code lengths of the first S-y segments helps reduce the delay of decoding and reporting.

Optionally, a segment code length of an (i+1)^{th} segment in the S segments is less than or equal to a segment code length of an (i+1)^{th} segment in the S segments.

It may be understood that, to avoid a case in which the delay of decoding and reporting is limited to reporting duration of the penultimate segment because an information bit length (a segment code length) of the last segment is much smaller than an information bit length (a segment code length) of the penultimate segment, in this embodiment of this application, a segment code length of a (j+1)^{th} segment in the last y segments is less than or equal to a segment code length of a j¹ segment in the last y segments, so that the segment code lengths of the last y segments are in a decreasing trend.

In some embodiments of this application, to implement that the segment code lengths of the last y segments of the S segments are less than the segment code lengths of the first S-y segments of the S segments, and the segment code length of the (j+1)^{th} segment of the last y segments is less than or equal to the segment code length of the j^{th} segment of the last y segments, after the code length N is determined, a specific quantity of segments are pre-reserved for a segment type whose segment code length is small in the b−a+1 types of segments.

Optionally, the determining, based on N, a minimum segment code length, and a maximum segment code length, a reserved segment quantity of each type of segments in segments of b−a+1 types of segment code lengths and a reserved code length corresponding to N, where a value of the minimum segment code length is 2\hat{ }^{a}, a value of the maximum segment code length is 2\hat{ }^{b}, the b−a+1 types of segment code lengths of the segments are 2\hat{ }^{c}, a, b, and c are positive integers, a<b, and a≤c≤b includes: determining the segments of the b−a+1 types of segment code lengths based on the minimum segment code length and the maximum segment code length, where the value of the minimum segment code length is 2\hat{ }^{a}, the value of the maximum segment code length is 2\hat{ }^{b}, the b−a+1 types of segment code lengths of the segments are 2\hat{ }^{c}, a, b, and c are positive integers, a<b, and a≤c≤b; orderly determining a reserved segment quantity of an i^{th} type of segments in the b−a+1 types of segments based on the b−a+1 types of segment code lengths of the segments from the smallest to the largest and based on N and the segment code length of each type of segments in the b−a+1 types of segments, where the reserved segment quantity of the i^{th} type of segments is greater than or equal to a reserved segment quantity of an (i+1)^{th} type of segments in the b−a+1 types of segments; and determining the reserved code length corresponding to N based on the reserved segment quantity of each type of segments and the segment code length of each type of segments.

Optionally, the determining, based on N, a minimum segment code length, and a maximum segment code length, a reserved segment quantity of each type of segments in segments of b−a+1 types of segment code lengths and a reserved code length corresponding to N includes: if N<p*2\hat{ }^{a}, determining that a reserved segment quantity that corresponds to N and that is of segments whose segment code lengths are 2\hat{ }^{a} is

$$floor ( \frac{N}{2 {\hat{}}^{a}} ) ,$$

and a reserved segment quantity that corresponds to N and that is of segments whose segment code lengths are 2\hat{ }^{j} is 0, where a<j≤b and p≥2; if

$$p * {\sum }_{i = a}^{c} 2 {\hat{}}^{i} \leq N < p * {\sum }_{i = a}^{c + 1} 2 {\hat{}}^{i} ,$$

determining that a reserved segment quantity that corresponds to N and that is of segments whose segment code lengths are 2\hat{ }^{j} is 0, a reserved segment quantity that corresponds to N and that is of segments whose segment code lengths are 2\hat{ }^{c+1} is

$$floor ( \frac{N - p * {\sum }_{i = a}^{c} 2 {\hat{}}^{i}}{2 {\hat{}}^{c + 1}} ) ,$$

and a reserved segment quantity that corresponds to N and that is of segments whose segment code lengths are 2\hat{ }^{v} is p, where a≤c≤b−1, a≤v≤c, and c+1<j≤b; or if

$$p * {\sum }_{i = a}^{b} 2 {\hat{}}^{i} \leq N ,$$

determining that the reserved segment quantity of each type of segments is p; and determining the reserved code length Nᵣₑₛ based on the reserved segment quantity of each type of segments, where

$${N}_{res} = {\sum }_{c = a}^{b} {m}_{c , N} * 2 {\hat{}}^{c} ,$$

and m_{c,N} represents a reserved segment quantity that corresponds to N and that is of segments whose segment code lengths are 2\hat{ }^{c}.

Relative to a receiving rate, when a reporting rate is very low, reporting of a last segment is not completed after a current segment is received. This causes a great impact on the delay of decoding and reporting. In this embodiment of this application, a value of p may be determined based on an actual case. Relative to the receiving rate, a lower reporting rate indicates a larger value of p.

Through implementation of the solution provided in this embodiment of this application, an adverse impact of a low reporting rate on the delay of decoding and reporting can be effectively reduced.

It should be noted that a Bluetooth bandwidth is equal to B₁, a reporting bandwidth is equal to B₂, and a code rate is R₀. N corresponds to the S segments, and the segment code length of the i^{th} segment and the segment code length of the (i+1)^{th} segment in the S segments are N₄ and N₅. Receiving duration of the (i+1)^{th} segment is

$$\frac{{N}_{5}}{{B}_{1}} ,$$

and reporting duration of the i^{th} segment is

$$\frac{{N}_{4} * {R}_{0}}{{B}_{2}} . If \frac{{N}_{4} * {R}_{0}}{{B}_{2}} > \frac{{N}_{5}}{{B}_{1}} ,$$

reporting of the i^{th} segment is not ended after receiving of the (i+1)^{th} segment is ended. Consequently, a start point of reporting of the (i+1)^{th} segment is affected, and in this case,

$${B}_{2} < \frac{{N}_{4} * {R}_{0}}{{N}_{5}} * {B}_{1} .$$

Therefore, in the foregoing case, a final delay of decoding and reporting may be affected. In this application, N₄≥N₅. To reduce an impact of reporting of the i^{th} segment on reporting of the (i+1)^{th} segment, N₄=N₅ may be set. Therefore, in this embodiment of this application, to effectively reduce an impact of reporting of the i^{th} segment on the delay of decoding and reporting, p segments are pre-reserved for segments of a same segment code length.

For example, the value of p is 2. If the minimum segment code length is 128, namely, 2\hat{ }⁷, and the maximum segment code length is 1024, namely, 2\hat{ }¹⁰, a reserved segment quantity of each type of segments in segments of four types of segment code lengths and the reserved code length corresponding to N are determined based on N, the minimum segment code length, and the maximum segment code length. This step includes: determining, based on the minimum segment code length and the maximum segment code length, that the four types of segment code lengths are 1024, 512, 256, and 128; and determining the reserved segment quantity of each type of segments in the four types of segments and the reserved code length corresponding to N, as shown in Table 1.

TABLE 1

| N | m_{10, N} | m_{9,N} | m_{8,N} | m_{7,N} |
|---|---|---|---|---|
| N < 256 | 0 | 0 | 0 | $floor ( \frac{N}{256} )$ |
| 256 ≤ N < 768 | 0 | 0 | $floor ( \frac{N - 256}{256} )$ | 2 |
| 768 ≤ N < 1792 | 0 | $floor ( \frac{N - 768}{512} )$ | 2 | 2 |
| 1792 ≤ N < 3840 | $floor ( \frac{N - 1792}{1024} )$ | 2 | 2 | 2 |
| 3840 ≤ N | 2 | 2 | 2 | 2 |

It may be understood that m_{10,N} represents a reserved segment quantity of the segments whose segment code lengths are 1024, m_{9,N} represents a reserved segment quantity of the segments whose segment code lengths are 512, m_{8,N} represents a reserved segment quantity of the segments whose segment code lengths are 256, and m_{7,N} represents a reserved segment quantity of the segments whose segment code lengths are 128. The value of p is 2. If N<256, the reserved code length corresponding to N is

$$floor ( \frac{N}{256} ) * {2}^{∧ 7} ;$$

if 256 N<768, the reserved code length corresponding to N is p*2\hat{ }⁷, namely, 256; if 768≤N<1792, the reserved code length corresponding to N is p*(2\hat{ }⁷+2\hat{ }⁸), namely, 768; if 1792≤N≤3840, the reserved code length corresponding to N is p*(2\hat{ }⁷+2\hat{ }⁸+2\hat{ }⁹), namely, 1792; or if 3840≤N, the reserved code length corresponding to N is p*(2\hat{ }⁷+2\hat{ }⁸+2\hat{ }⁸+2\hat{ }⁹), namely, 3840.

Examples in which the value of N is 1024, 2048, 3712, and 6144 are used for description. When the value of N is 1024, the reserved segment quantity corresponding to m_{9,N} is

$$floor ( \frac{1024 - 768}{512} ) ,$$

namely, 0, the reserved segment quantities of the four types of segments are 0, 0, 2, and 2, and the reserved code length corresponding to N is 768; when the value of N is 2048, the reserved segment quantity corresponding to m_{10,N} is

$$floor ( \frac{2048 - 1792}{1024} ) ,$$

namely, 0, the reserved segment quantities of the four types of segments are 0, 2, 2, and 2, and the reserved code length corresponding to N is 1792; when the value of N is 3712, the reserved segment quantity corresponding to m_{10,N} is

$$floor ( \frac{3712 - 1792}{1024} ) ,$$

namely, 1, the reserved segment quantities of the four types of segments are 1, 2, 2, and 2, and the reserved code length corresponding to N is 1920; and when the value of N is 6144, the reserved segment quantity corresponding to m_{10,N} is

$$floor ( \frac{6144 - 3840}{1024} ) ,$$

namely, 2, the reserved segment quantities of the four types of segments are 2, 1, 1, and 1, and the reserved code length corresponding to N is 3840.

Optionally, the determining, based on N, a minimum segment code length, and a maximum segment code length, a reserved segment quantity of each type of segments in segments of b−a+1 types of segment code lengths and a reserved code length corresponding to N includes: determining the b−a+1 types of segments based on the minimum segment code length and the maximum segment code length; if N<2\hat{ }^{a}, determining that the reserved segment quantity of each type of segments is 0; if

$${{\sum }^{c}}_{i = a} {2}^{∧ i} \leq N < {\sum }_{i = a}^{c + 1} {2}^{∧ i} ,$$

determining that a reserved segment quantity of segments whose segment code lengths are 2\hat{ }^{j} is 0, and a reserved segment quantity of segments whose segment code lengths are 2\hat{ }^{v} is 1, where a−c−b−1, a≤v≤c, and c<j≤b; or if

$${\sum }_{i = a}^{b} {2}^{∧ i} \leq N ,$$

determining that the reserved segment quantity of each type of segments is 1; and determining the reserved code length Nᵣₑₛ based on the reserved segment quantity of each type of segments, where

$${N}_{res} = {\sum }_{c = a}^{b} {m}_{c , N} * {2}^{∧ c} ,$$

and m_{c,N} represents a reserved segment quantity that corresponds to N and that is of segments whose segment code lengths are

$${2}^{∧ c} . {\sum }_{i = a}^{c} {2}^{∧ i}$$

indicates that superposition is performed on 2\hat{ }ⁱ with i changes, and a≤i≤c.

It may be understood that the solution in this embodiment of this application is a special case in which the value of P is 1. In this embodiment of this application, there is no need to reserve a plurality of segments for segments of a same segment code length. This solution is applicable to a case of

$${B}_{2} \geq \frac{{N}_{4} * {R}_{0}}{{N}_{5}} * {B}_{1} .$$

For example, if the minimum segment code length is 128, namely, 2\hat{ }⁷, and the maximum segment code length is 1024, namely, 2\hat{ }¹⁰, a reserved segment quantity of each type of segments in segments of four types of segment code lengths and the reserved code length corresponding to N are determined based on N, the minimum segment code length, and the maximum segment code length. This step includes: determining, based on the minimum segment code length and the maximum segment code length, that the four types of segment code lengths are 1024, 512, 256, and 128; and determining the reserved segment quantity of each type of segments in the four types of segments and the reserved code length corresponding to N, as shown in Table 2.

TABLE 2

| N | m_{10,N} | m_{9,N} | m_{8,N} | m_{7,N} |
|---|---|---|---|---|
| N < 128 | 0 | 0 | 0 | 0 |
| 128 ≤ N < 384 | 0 | 0 | 0 | 1 |
| 384 ≤ N < 896 | 0 | 0 | 1 | 1 |
| 896 ≤ N < 1920 | 0 | 1 | 1 | 1 |
| 1920 ≤ N | 1 | 1 | 1 | 1 |

It may be understood that if N<128, the reserved code length corresponding to N is 0; if 128≤N<384, the reserved code length corresponding to N is 2\hat{ }⁷; if 384≤N<896, the reserved code length corresponding to N is 2\hat{ }⁷+2\hat{ }⁸, namely, 384; if 896≤N<1920, the reserved code length corresponding to N is 2\hat{ }⁷+2\hat{ }⁸+2\hat{ }⁹, namely, 896; or if 1920<N, the reserved code length corresponding to N is 2\hat{ }⁷+2\hat{ }⁸+2\hat{ }⁸+2\hat{ }⁹, namely, 1920.

It can be learned from the foregoing example that in this embodiment of this application, a specific quantity of segments may be pre-reserved for segments whose segment code lengths are short, and a sum of segment code lengths of the reserved segments is the reserved code length.

S503: Orderly determine a segment quantity of each type of segments based on N, the reserved code length, a segment code length of each type of segments, and the reserved segment quantity of each type of segments and based on the segment code lengths from the largest to the smallest, where a sum of segment quantities of all types of segments is equal to S, N corresponds to S segments, and a segment code length of an i^{th} segment in the S segments is greater than or equal to a segment code length of an (i+1)^{th} segment in the S segments.

Optionally, the orderly determining a segment quantity of each type of segments based on N, the reserved code length, a segment code length of each type of segments, and the reserved segment quantity of each type of segments and based on the segment code lengths from the largest to the smallest includes: orderly determining a remaining segment quantity of each type of segments based on N, the reserved code length, and the segment code length of each type of segments and based on the segment code lengths from the largest to the smallest, where the remaining segment quantity of each type of segments is a remaining segment quantity of each type of segments corresponding to a remaining code length that is obtained by subtracting the reserved code length from N; and determining the segment quantity of each type of segments based on the reserved segment quantity of each type of segments and the remaining segment quantity of each type of segments.

In this embodiment of this application, the remaining code length obtained by subtracting the reserved code length from N is segmented again. The orderly determining a remaining segment quantity of each type of segments based on the segment code lengths from the largest to the smallest is as follows: preferentially allocating the remaining code length to a segment type whose segment code length is large.

It may be understood that a smaller segment quantity indicates better system performance. In an optional embodiment of step S503, to meet the delay limit of decoding and reporting, a quantity of segments is first reserved for a segment type whose segment code length is small. When the delay limit of decoding and reporting is met, in this embodiment of this application, the remaining code length is preferentially allocated to the segment type whose segment code length is large, so that a total segment quantity is as small as possible, even if S is as small as possible.

Optionally, the orderly determining a remaining segment quantity of each type of segments based on N, the reserved code length, and the segment code length of each type of segments and based on the segment code lengths from the largest to the smallest includes: if N<2\hat{ }^{a}, determining that a remaining segment quantity z_{c,N} that corresponds to N and that is of the segments whose segment code lengths are 2\hat{ }^{c} is 0, and a remaining segment quantity z_{a,N} that corresponds to N and that is of the segments whose segment code lengths are 2\hat{ }^{a} is 1, where a<c≤b; or if N>2\hat{ }^{a}, orderly determining the remaining segment quantity of each type of segments based on the segment code lengths from the largest to the smallest, and determining that a remaining segment quantity z_{b,N} that corresponds to N and that is of segments whose segment code lengths are 2\hat{ }^{b} is

$$floor ( \frac{N - {N}_{res}}{{2}^{∧ b}} ) ,$$

and a remaining segment quantity z_{c,N} that corresponds to N and that is of the segments whose segment code lengths are 2\hat{ }^{c} is

$$floor ( \frac{N - {N}_{r e s} - {\sum }_{e = c + 1}^{b} {Z}_{e , N} * {2}^{∧ e}}{{2}^{∧ c}} ) ,$$

where a≤c<b, and floor(x) represents rounding down x.

For example, if the minimum segment code length is 128, namely, 2\hat{ }⁷, and the maximum segment code length is 1024, namely, 2\hat{ }¹⁰ it is determined, based on the minimum segment code length and the maximum segment code length, that the four types of segment code lengths are 1024, 512, 256, and 128. Examples in which the value of N is 1024, 2048, 2560, and 6144 are used for description. When the value of N is 1024, the reserved segment quantities of the four types of segments are 0, 1, 1, and 1, the reserved code length corresponding to N is 896, and the remaining code length is 128; when the value of N is 2048, the reserved segment quantities of the four types of segments are 1, 1, 1, and 1, the reserved code length corresponding to N is 1920, and the remaining code length is 128; when the value of N is 2560, the reserved segment quantities of the four types of segments are 1, 1, 1, and 1, the reserved code length corresponding to N is 1920, and the remaining code length is 640; and when the value of N is 6144, the reserved segment quantities of the four types of segments are 1, 1, 1, and 1, the reserved code length corresponding to N is 1920, and the remaining code length is 4224. When the value of N is 1024, 2560, and 6144, corresponding remaining segment quantities of the four types of segments are shown in Table 3.

TABLE 3

| | Remaining | | | | |
|---|---|---|---|---|---|
| N | code length | z_{10,N} | z_{9,N} | z_{8,N} | z_{7,N} |
| 1024 | 128 | 0 | 0 | 0 | 1 |
| 2048 | 128 | 0 | 0 | 0 | 1 |
| 2560 | 640 | 0 | 1 | 0 | 1 |
| 6144 | 4224 | 4 | 0 | 0 | 1 |

It may be understood that z_{10,N} represents a reserved segment quantity of the segments whose segment code lengths are 1024, z_{9,N} represents a reserved segment quantity of the segments whose segment code lengths are 512, z_{8,N} represents a reserved segment quantity of the segments whose segment code lengths are 256, and z_{7,N} represents a reserved segment quantity of the segments whose segment code lengths are 128. It can be learned from the foregoing example that in this embodiment of this application, a remaining segment quantity can be first allocated to a segment type whose segment code length is large.

Optionally, the determining the segment quantity of each type of segments based on the reserved segment quantity of each type of segments and the remaining segment quantity of each type of segments includes: determining a segment quantity M_{c,N} that corresponds to N and that is of the segments whose segment code lengths are 2\hat{ }^{c}, where M_{c,N}=m_{c,N}=z_{c,N}, and a≤c≤b.

It may be understood that the segment quantity of the segments whose segment code lengths are 2\hat{ }^{c} is equal to a reserved segment quantity of the segments whose segment code lengths are 2\hat{ }^{c} plus a remaining segment quantity of the segments whose segment code lengths are 2\hat{ }^{c}.

For example, if the minimum segment code length is 128, and the maximum segment code length is 1024, it is determined, based on the minimum segment code length and the maximum segment code length, that the four types of segment code lengths are 1024, 512, 256, and 128. When the value of N is 2048, the reserved segment quantities that correspond to N and that are of the four types of segments are 1, 1, 1, and 1, and the remaining segment quantities that correspond to N and that are of the four types of segments are 0, 0, 0, and 1. Therefore, segment quantities that correspond to N and that are of the four types of segments are 1, 1, 1, and 2.

S504: Determine a target information bit length of each segment based on the code rate and a segment code length of each segment in the S segments.

Optionally, the determining a target information bit length of each segment based on the code rate and a segment code length of each segment in the S segments includes: determining that a target information bit length of a segment whose segment code length is 2\hat{ }^{c} in the S segments is ceil(2\hat{ }^{c}*R).

It may be understood that in this embodiment of this application, segment code rates of the S segments almost equal, and a segment code rate of a segment=a target information bit length of the segment/a segment code length of the segment. In this embodiment of this application, the target information bit length of each segment is determined based on the code rate R and the segment code length of each segment. To ensure that the target information bit length of the segment is a positive integer, (2\hat{ }^{c}*R) is rounded up. Therefore, a sum of target information bit lengths of the S segments is greater than or equal to the length K₀ of the to-be-encoded information bits.

It should be noted that in a same channel environment and a same segment code rate, a larger segment code length of a segment indicates a lower packet error rate and better performance. Therefore, a segment with a larger segment code length in the S segments has better performance.

Optionally, a difference between the sum of the target information bit lengths of the S segments and the length of the to-be-encoded information bits is k₀, and

$${k}_{0} = {\sum }_{c = a}^{b} {M}_{c , N} * ceil ( {2}^{∧ c} * R ) - {K}_{0} .$$

To ensure that the sum of the target information bit lengths of the S segments is equal to the length of the to-be-encoded information bits, the determining a target information bit length of each segment based on the code rate and a segment code length of each segment in the S segments includes: when the segment code length of the it segment in the S segments is 2\hat{ }^{e}, determining that a target information bit length of the i^{th} segment is ceil(2\hat{ }^{e}*R)−k₀, and a target information bit length of a segment that is in segments other than the it segment in the S segments and whose segment code length is 2\hat{ }^{c} is ceil(2\hat{ }^{c}*R). 1≤i≤S, i may be equal to 1, equal to S, or equal to another predetermined value. This is not specifically limited in this embodiment of this application.

Optionally, if the it segment in the S segments is an S^{th} segment in the S segments, the determining a target information bit length of each segment based on the code rate and a segment code length of each segment in the S segments includes: if

$${\sum }_{c = a}^{b} {M}_{c , N} * ceil ( {2}^{∧ c} * R ) = {K}_{0} ,$$

determining that a target information bit length of a segment whose segment code length is 2\hat{ }^{c} is ceil(2\hat{ }^{c}*R), where a≤c≤b; or if

$${\sum }_{c = a}^{b} {M}_{c , N} * ceil ( {2}^{∧ c} * R ) > {K}_{0} ,$$

determining that a target information bit length of a segment whose segment code length is 2\hat{ }^{c} is ceil(2\hat{ }^{c}*R), target information bit lengths that correspond to N and that are of the first M_{a,N}−1 segments in M_{a,N} segments whose segment code lengths are 2\hat{ }^{a} are ceil(2\hat{ }^{a}*R), and a target information bit length of an (M_{a,N})^{th} segment in the M_{a,N} segments is

$${K}_{0} - {\sum }_{c = a + 1}^{b} {M}_{c , N} * ceil ( {2}^{∧ c} * R ) + ( {M}_{a , N} - 1 ) * ceil ( {2}^{∧ a} * R ) ,$$

where the (M_{a,N})^{th} segment is an S^{th} segment in the S segments, and a<c b.

Optionally, the determining a target information bit length of each segment based on the code rate and a segment code length of each segment in the S segments includes: determining a reference information bit length of each segment; and determining the target information bit length of each segment based on the reference information bit length of each segment and the segment quantity of each type of segments.

It should be noted that in this embodiment of this application, the reference information bit length of each segment is determined first, and then the target information bit length of each segment is adjusted based on the reference information bit length and an actual requirement.

Optionally, the reference information bit length of the segment whose segment code length is 2\hat{ }^{c} in the S segments is ceil(2\hat{ }^{c}*R).

Optionally, the determining a target information bit length of each segment based on the code rate and a segment code length of each segment in the S segments includes: if

$${\sum }_{c = a}^{b} {M}_{c , N} * ceil ( {2}^{∧ c} * R ) = {K}_{0} ,$$

determining that a reference information bit length that corresponds to N and that is of a segment whose segment code length is 2\hat{ }^{c} is ceil(2\hat{ }^{c}*R), where a≤c≤b; or if

$${\sum }_{c = a}^{b} {M}_{c , N} * ceil ( {2}^{∧ c} * R ) > {K}_{0} ,$$

determining that a reference information bit length that corresponds to N and that is of a segment whose segment code length is 2\hat{ }^{c} is ceil(2\hat{ }^{c}*R), reference information bit lengths of the first M_{a,N}−1 segments in M_{a,N} segments are ceil(2\hat{ }^{a}*R), and a reference information bit length of an (M_{a,N})^{th} segment in the M_{a,N} segments is

$${K}_{0} - {\sum }_{c = a + 1}^{b} {M}_{c , N} * ceil ( {2}^{∧ c} * R ) + ( {M}_{a , N} - 1 ) * ceil ( {2}^{∧ a} * R ) ,$$

where the (M_{a,N})^{th} segment is an S^{th} segment in the S segments, and a<c≤b; and determining the target information bit length of each segment based on the reference information bit length of each segment and the segment quantity of each type of segments.

Optionally, the determining the target information bit length of each segment based on the reference information bit length of each segment and the segment quantity of each type of segments includes: determining the target information bit length of each segment according to an allocation principle. The allocation principle is that on the basis of the reference information bit length of each segment, a first information bit length is totally added to f segments whose segment code lengths are the largest in the S segments, h segments whose segment code lengths are not the largest in the S segments are reduced by totally the first information bit length, a segment with a smaller segment code length in the segments whose segment code lengths are not the largest has a smaller segment code rate, and a sum of target information bit lengths of the S segments is K₀, where f and h are positive integers.

It should be noted that a segment with a larger segment code length has better performance in a case of a same segment code rate. In this embodiment of this application, based on the reference information bit length, the target information bit length of each segment is adjusted, so that segment code rates of the segments whose segment code lengths are the largest in the S segments are increased, and segment code rates of the segments whose segment code lengths are not the largest in the S segments are decreased, thereby properly improving system performance of the segments whose segment code lengths are the largest, degrading system performance of the segments whose segment code lengths are not the largest, and implementing overall improvement of system performance. In addition, the segments whose segment code lengths are not the largest are segments of packet trailers of the S segments, and a segment having a smaller segment code length is more backward. Therefore, information bit lengths of the segments whose segment code lengths are not the largest may be adjusted, so that a segment with a smaller segment code length in the segments whose segment code lengths are not the largest has a smaller segment code rate. This improves overall system performance, and can further reduce the delay of decoding and reporting.

Optionally, the determining the target information bit length of each segment based on the reference information bit length of each segment and the segment quantity of each type of segments includes: determining a target information bit length of a first segment, where the target information bit length of the first segment is equal to a reference information bit length of the first segment plus a second information bit length, and the first segment is a segment whose segment code length is the largest in the S segments; and determining a target information bit length of a second segment, where the target information bit length of the second segment is equal to a reference information bit length of the second segment minus a third information bit length, and the second segment is a segment whose segment code length is not the largest in the S segments. In the S segments, h segments whose segment code lengths are not the largest are reduced by totally f times of the second information bit length, and a segment with a smaller segment code length in the segments whose segment code lengths are not the largest has a smaller segment code rate, where a sum of target information bit lengths of the S segments is K₀, f is a segment quantity of segments whose segment code lengths are the largest in the S segments, and h is a positive integer greater than or equal to 0.

Optionally, the determining the target information bit length of each segment based on the reference information bit length of each segment and the segment quantity of each type of segments includes: if a segment code length of a segment whose segment code length is the largest in the S segments is 2\hat{ }^{a}, determining that a target information bit length of the segment whose segment code length is 2\hat{ }^{a} is equal to a reference information bit length of the segment whose segment code length is 2\hat{ }^{a}; or if a segment code length of a segment whose segment code length is the largest in the S segments is 2\hat{ }^{r}, determining that a target information bit length of the segment whose segment code length is 2\hat{ }^{r} is a reference information bit length of the segment whose segment code length is 2\hat{ }^{r} plus

$${\sum }_{c = a}^{r - 1} {\partial }_{c} * {M}_{c , N} ,$$

and a target information bit length of a segment whose segment code length is 2\hat{ }^{c} is a reference information bit length of the segment whose segment code length is 2\hat{ }^{c} minus ∂_{c}*M_{r,N}, where a≤c<r, ∂_{c} is a proportion parameter, and ∂_{c} is a positive integer.

Optionally, 0<∂_{c+1}≤2∂_{c}.

It should be noted that 0<∂_{c+1}≤2∂_{c}, so that the segment code rates of the segments whose segment code lengths are not the largest are in a decreasing trend.

For example, if the minimum segment code length is 128, and the maximum segment code length is 1024, it is determined, based on the minimum segment code length and the maximum segment code length, that the four types of segment code lengths are 1024, 512, 256, and 128. The value of N is 2048, the value of K₀ is 1024, and the code rate is 0.5. It can be learned from derivation of the solution in this embodiment of this application that the segment quantities that correspond to N and that are of the four types of segments are 1, 1, 1, and 2. It is assumed that values of ∂₇, ∂₈, and ∂₉ are 2, 4, and 6. In this case, information bit lengths of the segments whose segment code lengths are 1024 are 526, information bit lengths of the segments whose segment code lengths are 512 are 250, information bit lengths of the segments whose segment code lengths are 256 are 124, and information bit lengths of the segments whose segment code lengths are 128 are 26. Segment code rates of the four types of segments are 0.5137, 0.4883, 0.4844, 0.4844, and 0.4844. Therefore, it can be learned that the segment code lengths of the four types of segments are in a decreasing trend, and the segment code rates of the four types of segments are also in a decreasing trend.

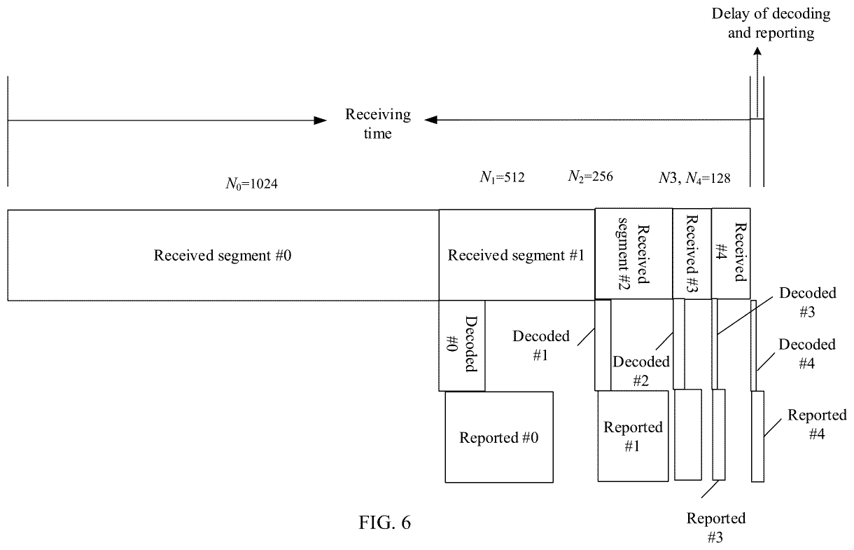

Based on the foregoing example, FIG. 6 is a schematic diagram of a delay of decoding and reporting according to an embodiment of this application. If a reporting bandwidth is equal to 8 Mb/s, a reporting delay of a last segment is equal to 3.25 μs. Because a time difference of decoding and reporting of the last segment may be ignored, the delay of decoding and reporting is approximately equal to 3.25 μs, which meets the 15 μs delay limit of decoding and reporting.

Based on the foregoing example, the value of K₀ is 1024, and the code rate is 0.5. Under same network parameters, segmentation is performed based on the first segmentation manner, a to-be-encoded information sequence is divided into two parts, an information bit length of a second segment is 512, and a segment code length is 1024. The delay of decoding and reporting is approximately equal to 64 μs, which far exceeds the 15 μs delay limit of decoding and reporting. Under same network parameters, segmentation is performed based on the first segmentation manner, a to-be-encoded information sequence is divided into two parts, a segment code length of a second segment is 1024, and an information bit length is 512. The delay of decoding and reporting is also approximately equal to 64 μs, which far exceeds the 15 μs delay limit of decoding and reporting.

Based on the foregoing analysis, the solution proposed in this embodiment of this application can greatly optimize the delay of decoding and reporting.

It should be noted that in this embodiment of this application, when the segment quantities M_{b,N} of the segments whose segment code lengths are the largest are large, an information bit length added for the segments whose segment code lengths are the largest in the S segments is excessively large. In addition, the information bit length reduced for the segments whose segment code lengths are not the largest in the S segments is excessively large.

Optionally, to resolve the foregoing problem, if M_{b,N}>T, and T is a positive integer, the determining the target information bit length of each segment based on the reference information bit length of each segment and the segment quantity of each type of segments includes: determining that target information bit lengths of the first T segments in M_{b,N} segments whose segment code lengths are 2\hat{ }^{b} are a reference information bit length of the segment whose segment code length is 2\hat{ }^{b} plus

$${\sum }_{c = a}^{b - 1} {\partial }_{c} * {M}_{c , N} ,$$

target information bit lengths of the last M_{b,N}−T segments in the M_{b,N} segments are equal to the reference information bit length of the segment whose segment code length is 2\hat{ }^{b}, and a target information bit length of a segment whose segment code length is 2\hat{ }^{c} is a reference information bit length of the segment whose segment code length is 2\hat{ }^{c} minus ∂_{c}*T, where a≤c<b, ∂_{c} is a positive integer, and ∂_{c+1}>∂_{c}.

It should be noted that, to resolve the foregoing problem, in this embodiment of this application, information bits are added for only the first T segments in the M_{b,N} segments whose segment code lengths are 2\hat{ }^{b} and the information bit length is properly reduced, with T as a reference amount, for the segments whose segment code lengths are not the largest. In this embodiment of this application, segment code rates of the first T segments are greater than segment code rates of the last M_{b,N}−T segments.

S505: Perform polar code encoding on the to-be-encoded information bits based on the target information bit length of each segment.

Optionally, the performing polar code encoding on the to-be-encoded information bits based on the target information bit length of each segment includes: orderly allocating the to-be-encoded information bits to the S segments based on the target information bit length of each segment, and performing polar code encoding on information bits of each segment.

Optionally, the performing polar code encoding on the to-be-encoded information bits based on the target information bit length of each segment includes: if

$${\sum }_{c = a}^{b} {M}_{c , N} * ceil ( {2}^{∧ c} * R ) = {K}_{0} ,$$

orderly allocating the to-be-encoded information bits to the S segments based on the target information bit length of each segment, and performing polar code encoding on information bits of each segment; or if

$${\sum }_{c = a}^{b} {M}_{c , N} * ceil ( {2}^{∧ c} * R ) > {K}_{0} ,$$

performing zero-padding on to-be-encoded information bits whose information bit length is K₀, where the information bit length of the to-be-encoded information bits after zero-padding is

$${\sum }_{c = a}^{b} {M}_{c , N} * ceil ( {2}^{∧ c} * R ) ,$$

orderly allocating the to-be-encoded information bits after zero-padding to the S segments based on the target information bit length of each segment, and performing polar code encoding on information bits of each segment.

It may be understood that in this embodiment of this application, a round up operation is used in a process of determining the target information bit length of each segment, so that the sum of the target information bit lengths of the S segments corresponding to N is greater than the length of the to-be-encoded information bits. In this embodiment of this application, through a zero-padding operation, the length of the to-be-encoded information bits after zero-padding is equal to the sum of the target information bit lengths of the S segments. This helps subsequently perform polar code encoding on each segment.

Optionally, the performing zero-padding on to-be-encoded information bits whose information bit length is K₀ includes: performing zero-padding at a preset location in the to-be-encoded information bits whose information bit length is K₀.

Optionally, zero-padding is performed at a front end of the to-be-encoded information bits whose information bit length is K₀, or zero-padding is performed at a tail end of the to-be-encoded information bits whose information bit length is K₀.

In this embodiment of this application, the segments of the b−a+1 types of segment code lengths are determined based on the minimum segment code length and the maximum segment code length, the value of the minimum segment code length is 2\hat{ }^{a}, and the value of the maximum segment code length is 2\hat{ }^{b}; and the code length N after encoding is divided into the S segments based on the minimum segment code length and the b−a+1 types of segment code lengths of the segments, the segment code length of the i^{th} segment in the S segments is greater than or equal to the segment code length of the (i+1)^{th} segment in the S segments, and the to-be-encoded information bits are allocated to the S segments for polar code encoding. In the proposed solution, rate matching does not need to be performed, so that overheads brought by rate matching are avoided. In addition, segment code lengths of segments of a packet trailer of a data packet after segmentation are in a decreasing trend. This can effectively improve performance of a low-power communication system when a low delay requirement is met. In addition, in this embodiment of this application, based on the reference information bit length, the target information bit length of each segment is adjusted, so that the segment code rates of the segments whose segment code lengths are the largest in the S segments are increased, and the segment code rates of the segments whose segment code lengths are not the largest in the S segments are decreased, thereby improving the overall system performance. In addition, the information bit lengths of the segments whose segment code lengths are not the largest are adjusted, so that a segment with a smaller segment code length in the segments whose segment code lengths are not the largest has a smaller segment code rate. This improves the overall system performance, can further reduce the delay of decoding and reporting, matches an existing communication system, and reduces modifications to the existing system.

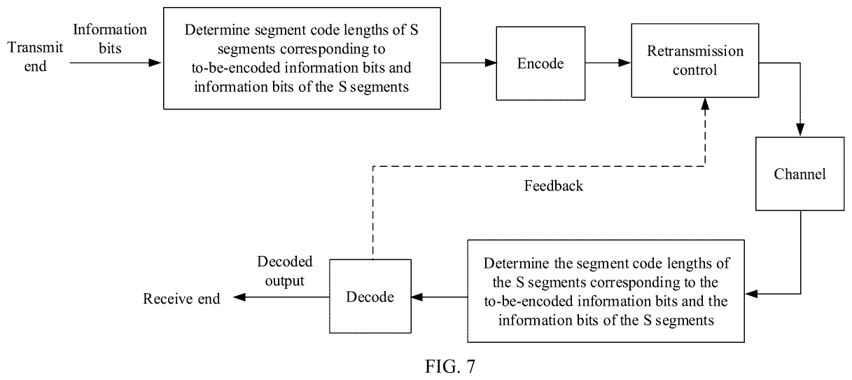

FIG. 7 is a schematic diagram of a principle of polar code segment encoding and segment decoding according to an embodiment of this application. A transmit end determines, according to the polar code segment encoding method provided in the embodiments of this application, segment code lengths of S segments corresponding to to-be-encoded information bits and information bits of the S segments, and performs polar code segment encoding based on the segment code lengths of the S segments and the information bits of the S segments. A receive end determines, according to the polar code segment encoding method provided in the embodiments of this application, the segment code lengths of the S segments corresponding to the to-be-encoded information bits and the information bits of the S segments. After receiving data, the receive end performs polar code segment decoding based on the segment code lengths of the S segments and the information bits of the S segments. After decoding, whether the received data is correct is determined through check. If the received data is correct, ACK information is replied to the transmit end, to tell the transmit end that this time of receiving is correct. If the CRC check fails, the receive end considers that the data received this time is incorrect, and the receive end feeds back or replies negative acknowledgment (NACK) information to the transmit end, to tell the transmit end that this time of receiving is incorrect, so that the transmit end performs retransmission. After receiving retransmitted information, the receive end continuously performs polar code segment decoding, and check whether retransmitted data is correct. The transmit end may be the terminal device 101 or the Bluetooth headset 102 shown in the Bluetooth communication system in FIG. 1. The receive end may be the terminal device 101 or the Bluetooth headset 102 shown in the Bluetooth communication system in FIG. 1.

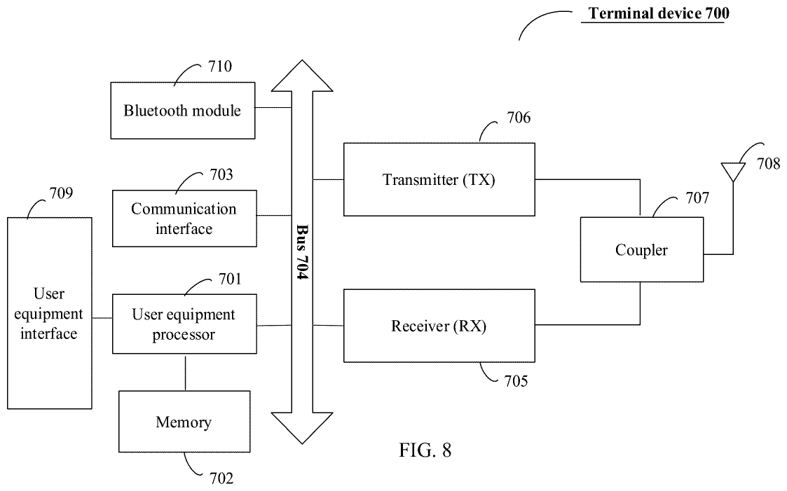

FIG. 8 shows a terminal device 700 according to an embodiment of this application. As shown in FIG. 8, the terminal device 700 may include one or more terminal device processors 701, a memory 702, a communication interface 703, a receiver 705, a transmitter 706, a coupler 707, an antenna 708, a terminal device interface 709, and a Bluetooth module 710. These components may be connected through a bus 704 or in another manner. In FIG. 8, an example in which the components are connected through the bus is used.

The communication interface 703 may be configured to perform communication between the terminal device 700 and another communication device, for example, a network device. Specifically, the network device may be the network device 700 shown in FIG. 8. Specifically, the communication interface 703 may be a 5G communication interface, or may be a communication interface of future new radio. In addition to a wireless communication interface, a wired communication interface 703 may be further configured for the terminal device 700, for example, a local access network (LAN) interface. The transmitter 706 may be configured to transmit a signal output by the terminal device processor 701. The receiver 705 may be configured to receive a mobile communication signal received by the antenna 708.

In some embodiments of this application, the transmitter 706 and the receiver 705 may be considered as a wireless modem. In the terminal device 700, there may be one or more transmitters 706 and receivers 705. The antenna 708 may be configured to convert electromagnetic energy in a transmission line into an electromagnetic wave in free space, or convert an electromagnetic wave in free space into electromagnetic energy in a transmission line. The coupler 707 is configured to divide the mobile communication signal received by the antenna 708 into a plurality of channels, and allocate the plurality of channels of signals to the plurality of receivers 705.

In addition to the transmitter 706 and the receiver 705 shown in FIG. 8, the terminal device 700 may further include another communication component, for example, a GPS module or a wireless fidelity (Wi-Fi) module. In addition to wireless communication, a wired network interface (for example, a LAN interface) may be further configured for the terminal device 700, to support wired communication.

The terminal device 700 may further include input/output modules. The input/output modules may be configured to implement interaction between the terminal device 700 and a terminal device/an external environment, and may mainly include an audio input/output module, a key input module, a display, and the like. Specifically, the input/output module may further include a camera, a touchscreen, a sensor, and the like. All the input/output modules communicate with the terminal device processor 701 through the terminal device interface 709.

The memory 702 is coupled to the terminal device processor 701, and is configured to store various software programs and/or a plurality of groups of instructions. Specifically, the memory 702 may include a high-speed random access memory, and may also include a nonvolatile memory, for example, one or more magnetic disk storage devices, a flash memory device, or another nonvolatile solid-state storage device. The memory 702 may store an operating system (referred to as a system for short below), for example, an embedded operating system such as Android, iOS, Windows, or Linux. The memory 702 may further store a network communication program. The network communication program may be used to communicate with one or more additional devices, one or more terminal devices, and one or more network devices.

In some embodiments of this application, the memory 702 may be configured to store an implementation program of the polar code segment encoding method provided in one or more embodiments of this application on the terminal device 700 side. For implementation of the polar code segment encoding method provided in one or more embodiments of this application, refer to the foregoing embodiments.

The terminal device processor 701 may be configured to read computer-readable instructions and execute the computer-readable instructions. Specifically, the terminal device processor 701 may be configured to call a program stored in the memory 702, for example, the implementation program of the polar code segment encoding method provided in one or more embodiments of this application on the terminal device 700 side, and execute instructions included in the program.

It may be understood that the terminal device 700 may be the terminal device 101 in the communication system 100 shown in FIG. 1, and may be implemented as a handheld device, a vehicle-mounted device, a wearable device, a computing device, user equipment in various forms, a mobile station (English: Mobile Station, MS for short), a terminal, or the like.

It should be noted that the terminal device 700 shown in FIG. 8 is merely an implementation of the embodiments of this application, and in actual application, the terminal device 700 may further include more or fewer components. This is not limited herein.

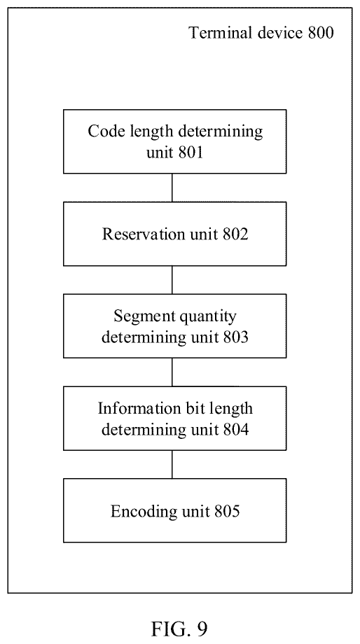

FIG. 9 shows a schematic diagram of a structure of a polar code segment encoding apparatus according to this application. The polar code segment encoding apparatus 80 may also be the terminal device 101 or the Bluetooth headset 102 in FIG. 1. The polar code segment encoding apparatus 80 may include a code length determining unit 801, a reservation unit 802, a segment quantity determining unit 803, an information bit length determining unit 804, and an encoding unit 805.

The code length determining unit 801 is configured to determine, based on a length of to-be-encoded information bits and a code rate, a code length N after encoding, where N is a positive integer.

The reservation unit 802 is configured to determine, based on N, a minimum segment code length, and a maximum segment code length, a reserved segment quantity of each type of segments in segments of b−a+1 types of segment code lengths and a reserved code length corresponding to N, where a value of the minimum segment code length is 2\hat{ }^{a}, a value of the maximum segment code length is 2\hat{ }^{b}, the b−a+1 types of segment code lengths of the segments are 2\hat{ }^{c}, a, b, and c are positive integers, a<b, and a≤c≤b.

The segment quantity determining unit 803 is configured to orderly determine a segment quantity of each type of segments based on N, the reserved code length, a segment code length of each type of segments, and the reserved segment quantity of each type of segments and based on the segment code lengths from the largest to the smallest, where a sum of segment quantities of all types of segments is equal to S, N corresponds to S segments, and a segment code length of an i^{th} segment in the S segments is greater than or equal to a segment code length of an (i+1)^{th} segment in the S segments.

The information bit length determining unit 804 is configured to determine a target information bit length of each segment based on the code rate and a segment code length of each segment in the S segments.

The encoding unit 805 is configured to perform polar code encoding on the to-be-encoded information bits based on the target information bit length of each segment.

Optionally, the code length determining unit 801 is specifically configured to: determine a theoretical code length L based on the length K₀ of the to-be-encoded information bits and the code rate R, where a value of the theoretical code length is ceil(K₀/R), and ceil(x) represents rounding up X; and determine N based on the theoretical code length and the minimum segment code length 2\hat{ }^{a}, where a value of N is ceil(L/2\hat{ }^{a})*2\hat{ }^{a}.

Optionally, the reservation unit 802 is specifically configured to: determine the segments of the b−a+1 types of segment code lengths based on the minimum segment code length and the maximum segment code length, where the value of the minimum segment code length is 2\hat{ }^{a}, the value of the maximum segment code length is 2\hat{ }^{b}, the b−a+1 types of segment code lengths of the segments are 2\hat{ }^{c}, a, b, and c are positive integers, a<b, and a≤c≤b; orderly determine a reserved segment quantity of an i^{th} type of segments in the b−a+1 types of segments based on the b−a+1 types of segment code lengths of the segments from the smallest to the largest and based on N and the segment code length of each type of segments in the b−a+1 types of segments, where the reserved segment quantity of the i^{th} type of segments is greater than or equal to a reserved segment quantity of an (i+1)^{th} type of segments in the b−a+1 types of segments; and determine the reserved code length corresponding to N based on the reserved segment quantity of each type of segments and the segment code length of each type of segments.

Optionally, the reservation unit 802 is specifically configured to: if N<p*2\hat{ }^{a}, determine that a reserved segment quantity that corresponds to N and that is of segments whose segment code lengths are 2\hat{ }^{a} is

$$floor ( \frac{N}{{2}^{∧ a}} ) ,$$

and a reserved segment quantity that corresponds to N and that is of segments whose segment code lengths are 2\hat{ }^{j} is 0, where a<j≤b, and p≥2; if

$$p * {\sum }_{i = a} {2}^{∧ i} \leq N < p * {\sum }_{i = a}^{c + 1} {2}^{∧ i} ,$$

determine that a reserved segment quantity that corresponds to N and that is of segments whose segment code lengths are 2\hat{ }^{j} is 0, a reserved segment quantity that corresponds to N and that is of segments whose segment code lengths are 2\hat{ }^{c+1} is

$$floor ( \frac{N - p * {\sum }_{i = a}^{c} {2}^{∧ i}}{{2}^{∧ c + 1}} ) ,$$

and a reserved segment quantity that corresponds to N and that is of segments whose segment code lengths are 2\hat{ }^{v} is p, where a≤c≤b−1, a≤v≤c, and c+1<j≤b; or if

$$p * {\sum }_{i = a}^{b} {2}^{∧ i} \leq N ,$$

determine that the reserved segment quantity of each type of segments is p; and determine the reserved code length Nᵣₑₛ based on the reserved segment quantity of each type of segments, where

$${N}_{res} = {\sum }_{c = a}^{b} {m}_{c , N} * {2}^{∧ c} ,$$

and m_{c,N} represents a reserved segment quantity that corresponds to N and that is of segments whose segment code lengths are 2\hat{ }^{c}.

Optionally, the reservation unit 802 is specifically configured to: if N<2\hat{ }^{a}, determine that the reserved segment quantity of each type of segments is 0; if

$${{\sum }^{c}}_{i = a} {2}^{∧ i} \leq N < {\sum }_{i = a}^{c + 1} {2}^{∧ i} ,$$

determine that a reserved segment quantity of segments whose segment code lengths are 2\hat{ }^{j} is 0, and a reserved segment quantity of segments whose segment code lengths are 2\hat{ }^{v} is 1, where a≤c≤b−1, a≤v≤c, and c<j≤b; or if

$${\sum }_{i = a}^{b} 2 {\hat{}}^{i} \leq N ,$$

determine that the reserved segment quantity of each type of segments is 1; and determine the reserved code length Nᵣₑₛ based on the reserved segment quantity of each type of segments, where

$${N}_{res} = {\sum }_{c = a}^{b} {m}_{c , N} * 2 {\hat{}}^{c} ,$$

m_{c,N} represents a reserved segment quantity that corresponds to N and that is of segments whose segment code lengths are 2\hat{ }^{c}.

Optionally, the segment quantity determining unit 803 includes a remaining segment quantity determining unit 803 and a segment quantity determining subunit 803.

The remaining segment quantity determining unit 803 is configured to orderly determine a remaining segment quantity of each type of segments based on N, the reserved code length, and the segment code length of each type of segments and based on the segment code lengths from the largest to the smallest, where the remaining segment quantity of each type of segments is a remaining segment quantity of each type of segments corresponding to a remaining code length that is obtained by subtracting the reserved code length from N.

The segment quantity determining subunit 803 is configured to determine the segment quantity of each type of segments based on the reserved segment quantity of each type of segments and the remaining segment quantity of each type of segments.

Optionally, the remaining segment quantity determining unit 803 is specifically configured to: if N<2\hat{ }^{a}, determine that a remaining segment quantity z_{c,N} that corresponds to N and that is of the segments whose segment code lengths are 2\hat{ }^{c} is 0, and a remaining segment quantity z_{a,N} that corresponds to N and that is of the segments whose segment code lengths are 2\hat{ }^{a} is 1, where a<c≤b; or if N≥2\hat{ }^{a}, orderly determine the remaining segment quantity of each type of segments based on the segment code lengths from the largest to the smallest, and determine that a remaining segment quantity z_{b,N} that corresponds to N and that is of segments whose segment code lengths are 2\hat{ }^{b} is

$$floor ( \frac{N - {N}_{res}}{2 {\hat{}}^{b}} ) ,$$

and a remaining segment quantity z_{c,N} that corresponds to N and that is of the segments whose segment code lengths are 2\hat{ }^{c} is

$$floor ( \frac{N - {N}_{res} - {\sum }_{e = c + 1}^{b} {z}_{e , N} * 2 {\hat{}}^{e}}{2 {\hat{}}^{c}} ) ,$$

where a≤c<b, and floor(x) represents rounding down x.

Optionally, the segment quantity determining subunit 803 is specifically configured to: determine a segment quantity M_{c,N} that corresponds to N and that is of the segments whose segment code lengths are 2\hat{ }^{c}, where M_{c,N}=m_{c,N}+z_{c,N}, and a≤c≤b.

Optionally, the information bit length determining unit 804 is specifically configured to: determine that a target information bit length of a segment whose segment code length is 2\hat{ }^{c} in the S segments is ceil(2\hat{ }^{c}*R).

Optionally, the information bit length determining unit 804 is specifically configured to: if

$${\sum }_{c = a}^{b} {M}_{c , N} * ceil ( 2 {\hat{}}^{c} * R ) = {K}_{0} ,$$

determine that a target information bit length of a segment whose segment code length is 2\hat{ }^{c} is ceil(2\hat{ }^{c}*R), where a≤c≤b; or if

$${\sum }_{c = a}^{b} {M}_{c , N} * ceil ( 2 {\hat{}}^{c} * R ) > {K}_{0} ,$$

determine that a target information bit length of a segment whose segment code length is 2\hat{ }^{c} is ceil(2\hat{ }^{c}*R), target information bit lengths that correspond to N and that are of the first M_{a,N}−1 segments in M_{a,N} segments whose segment code lengths are 2\hat{ }^{a} are ceil(2\hat{ }^{c}*R), and a target information bit length of an (M_{a,N})^{th} segment in the M_{a,N} segments is

$${K}_{0} - {\sum }_{c = a + 1}^{b} {M}_{c , N} * ceil ( 2 {\hat{}}^{c} * R ) + ( {M}_{a , N} - 1 ) * ceil ( 2 {\hat{}}^{a} * R ) ,$$

where the (M_{a,N})^{th} segment is an S^{th} segment in the S segments, and a<c≤b.

Optionally, the information bit length determining unit 804 includes a reference information bit length determining unit 804 and a target information bit length determining unit 804.

The reference information bit length determining unit 804 is configured to determine a reference information bit length of each segment.

The target information bit length determining unit 804 is configured to determine the target information bit length of each segment based on the reference information bit length of each segment and the segment quantity of each type of segments.

Optionally, the reference information bit length determining unit 804 is specifically configured to: if

$${\sum }_{c = a}^{b} {M}_{c , N} * ceil ( 2 {\hat{}}^{c} * R ) = {K}_{0} ,$$

determine that a reference information bit length that corresponds to N and that is of a segment whose segment code length is 2\hat{ }^{c} is ceil(2\hat{ }^{c}*R) where a≤c≤b; or if

$${\sum }_{c = a}^{b} {M}_{c , N} * ceil ( 2 {\hat{}}^{c} * R ) > {K}_{0} ,$$

determine that a reference information bit length that corresponds to N and that is of a segment whose segment code length is 2\hat{ }^{c} is ceil(2\hat{ }^{c}*R) reference information bit lengths of the first M_{a,n}−1 segments in M_{a,N} segments are ceil(2\hat{ }^{a}*R) and a reference information bit length of an (M_{a,N})^{th} segment in the M_{a,N} segments is

$${K}_{0} - {\sum }_{c = a + 1}^{b} {M}_{c , N} * ceil ( 2 {\hat{}}^{c} * R ) + ( {M}_{a , N} - 1 ) * ceil ( 2 {\hat{}}^{a} * R ) ,$$

where the (M_{a,N})^{th} segment is an S^{th} segment in the S segments, and a<c≤b.

Optionally, the reference information bit length of the segment whose segment code length is 2\hat{ }^{c} in the S segments is ceil(2\hat{ }^{c}*R).

Optionally, the target information bit length determining unit 804 is specifically configured to determine the target information bit length of each segment according to an allocation principle. The allocation principle is that on the basis of the reference information bit length of each segment, a first information bit length is added to f segments whose segment code lengths are the largest in the S segments, h segments whose segment code lengths are not the largest in the S segments are reduced by totally the first information bit length, a segment code rate of a (j+1)^{th} segment in the h segments is less than or equal to a segment code rate of a j^{th} segment in the h segments, a segment code length of the (j+1)^{th} segment is less than or equal to a segment code length of the j^{th} segment, and a sum of target information bit lengths of the S segments is K₀, where f and h are positive integers, and a segment code rate of a segment=a target information bit length of the segment/a segment code length of the segment.

Optionally, the target information bit length determining unit 804 is specifically configured to: determine a target information bit length of a first segment, where the target information bit length of the first segment is equal to a reference information bit length of the first segment plus a second information bit length, and the first segment is a segment whose segment code length is the largest in the S segments; and determine a target information bit length of a second segment, where the target information bit length of the second segment is equal to a reference information bit length of the second segment minus a third information bit length, and the second segment is a segment whose segment code length is not the largest in the S segments. In the S segments, h segments whose segment code lengths are not the largest are reduced by totally f times of the second information bit length, where a segment code rate of a (j+1)^{th} segment in the h segments is less than or equal to a segment code rate of a j^{th} segment in the h segments, a segment code length of the (j+1)^{th} segment is less than or equal to a segment code length of the j^{th} segment, a sum of target information bit lengths of the S segments is K₀, f is a segment quantity of segments whose segment code lengths are the largest in the S segments, and h is a positive integer greater than or equal to 0.

Optionally, the target information bit length determining unit 804 is specifically configured to: if a segment code length of a segment whose segment code length is the largest in the S segments is 2\hat{ }^{a}, determine that a target information bit length of the segment whose segment code length is 2\hat{ }^{a} is equal to a reference information bit length of the segment whose segment code length is 2\hat{ }^{a}; or if a segment code length of a segment whose segment code length is the largest in the S segments is 2\hat{ }^{r}, determine that a target information bit length of the segment whose segment code length is 2\hat{ }^{r} is a reference information bit length of the segment whose segment code length is 2\hat{ }^{r} plus

$${\sum }_{c = a}^{r - 1} {\partial }_{c} * {M}_{c , N} ,$$

and a target information bit length of a segment whose segment code length is 2\hat{ }^{c} is a reference information bit length of the segment whose segment code length is 2\hat{ }^{c} minus ∂_{c}*M_{r,N}, where a≤c<r, ∂_{c} is a proportion parameter, and ∂_{c} is a positive integer.

Optionally, 0<∂_{c+1}≤2∂_{c}.

Optionally, if M_{b,N}>T, and T is a positive integer, the target information bit length determining unit 804 is specifically configured to: determine that target information bit lengths of the first T segments in M_{b,N} segments whose segment code lengths are 2\hat{ }^{b} are a reference information bit length of the segment whose segment code length is 2\hat{ }^{b} plus

$${\sum }_{c = a}^{b - 1} {\partial }_{c} * {M}_{c , N} ,$$

target information bit lengths of the last M_{b,N}−T segments in the M_{b,N} segments are equal to the reference information bit length of the segment whose segment code length is 2\hat{ }^{b}, and a target information bit length of a segment whose segment code length is 2\hat{ }^{c} is a reference information bit length of the segment whose segment code length is 2\hat{ }^{c} minus ∂_{c}*T, where a≤c<b, ∂_{c} is a positive integer, and ∂_{c+1}>∂_{c}.

Optionally, the encoding unit 805 is specifically configured to: orderly allocate the to-be-encoded information bits to the S segments based on the target information bit length of each segment, and perform polar code encoding on information bits of each segment.

Optionally, the encoding unit 805 is specifically configured to: if

$${\sum }_{c = a}^{b} {M}_{c , N} * ceil ( 2 {\hat{}}^{c} * R ) = {K}_{0} ,$$

orderly allocate the to-be-encoded information bits to the S segments based on the target information bit length of each segment, and perform polar code encoding on information bits of each segment; or if

$${\sum }_{c = a}^{b} {M}_{c , N} * ceil ( 2 {\hat{}}^{c} * R ) > {K}_{0} ,$$

perform zero-padding on to-be-encoded information bits whose information bit length is K₀, where the information bit length of the to-be-encoded information bits after zero-padding is

$${\sum }_{c = a}^{b} {M}_{c , N} * ceil ( 2 {\hat{}}^{c} * R ) ,$$

orderly allocate the to-be-encoded information bits after zero-padding to the S segments based on the target information bit length of each segment, and perform polar code encoding on information bits of each segment.

An embodiment of this application further provides a chip system 900, including one or more processors 901 and an interface circuit 902. The processor 901 is connected to the interface circuit 902.

The processor 901 may be an integrated circuit chip and has a signal processing capability. In an implementation process, steps in the foregoing methods can be implemented by a hardware integrated logical circuit in the processor 901, or by instructions in a form of software. The processor 901 may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor 901 may implement or perform the methods and steps that are disclosed in the embodiments of this application. The general-purpose processor may be a microprocessor, any conventional processor, or the like.

The interface circuit 902 may send or receive data, instructions, or information. The processor 901 may process data, instructions, or other information received through the interface circuit 902, and send, through the interface circuit 902, information obtained after processing.

Optionally, the chip system further includes a memory 903. The memory 903 may include a read-only memory and a random access memory, and provide operation instructions and data for the processor. A part of the memory 903 may further include a non-volatile random access memory (NVRAM).

Optionally, the memory 903 stores an executable software module or a data structure, and the processor 903 may perform a corresponding operation by invoking an operation instruction stored in the memory (where the operation instruction may be stored in an operating system).

Optionally, the chip system may be used in the terminal device or the Bluetooth headset related to the embodiments of this application.

An embodiment of this application further provides a computer-readable storage medium. The method described in the foregoing method embodiments may be all or partially implemented by using software, hardware, firmware, or any combination thereof. If implemented in software, the function may be stored as one or more instructions or code on the computer-readable medium or transmitted on a computer-readable medium. The computer-readable medium may include a computer storage medium and a communication medium, and may further include any medium capable of transferring a computer program from one place to another. The storage medium may be any available medium accessible to a computer.

In an optional design, the computer-readable medium may include a RAM, a ROM, an EEPROM, a CD-ROM or another optical disc memory, a magnetic disk memory or another magnetic storage device, or any other medium that may be used for carrying or required program code is stored in a form of an instruction or a data structure, and is accessible to a computer. In addition, any connection may be appropriately referred to as a computer-readable medium. For example, if software is transmitted from a website, a server, or another remote source by using a coaxial cable, a fiber optical cable, a twisted pair, a digital subscriber line (DSL), or wireless technologies (for example, infrared ray, radio, and microwave), the coaxial cable, the fiber optical cable, the twisted pair, the DSL, or the wireless technologies such as infrared ray, radio and microwave are included in the definition of a medium. Disks and discs as used herein include optical discs (CDs), laser discs, optical discs, digital versatile discs (DVDs), floppy disks, and Blu-ray discs, where disks typically reproduce data magnetically, and discs reproduce data optically using lasers. The combination described above should also be included in the scope of the computer-readable medium.

An embodiment of this application further provides a computer program product. The method described in the foregoing method embodiments may be all or partially implemented by using software, hardware, firmware, or any combination thereof. If implemented in software, it may be implemented completely or partially in the form of a computer program product. The computer program product includes one or more computer instructions. When the foregoing computer program instructions are loaded and executed on the computer, the procedure or functions described according to the foregoing method embodiments are all or partially generated. The foregoing computer may be a general-purpose computer, a dedicated computer, a computer network, a network device, a user device, or other programmable apparatuses.

In conclusion, the foregoing embodiments are merely intended for describing the technical solutions of this application, but not for limiting this application. Although this application is described in detail with reference to the foregoing embodiments, a person of ordinary skill in the art should understand that modifications to the technical solutions recorded in the foregoing embodiments or equivalent replacements to some technical features thereof may still be made, without departing from the scope of the technical solutions of the embodiments of this application.

1. A polar code segment encoding method, comprising:
performing segmentation of to-be-encoded information bits into respective quantities of different types of segments, wherein:
the different types of segments are among (b−a+1) types of segments that correspond to (b−a+1) different segment code lengths, wherein:
a and b are positive integers,
the (b−a+1) types of segments comprise a minimum-length segment that has the minimum segment code length of 2\hat{ }^{a} among the (b−a+1) types of segment code lengths, and a maximum-length segment that has the maximum segment code length of 2\hat{ }^{b} among the (b−a+1) types of segment code lengths,
the respective quantities of the different types of segments are determined based on a length of the to-be-encoded information bits and a code rate, wherein the respective quantities of the different types of segments are determined by firstly determining a quantity of the maximum-length segments and lastly determining a quantity of the minimum-length segments, and
performing polar code encoding on the respective quantities of the different types of segments of the to-be-encoded information bits to obtain encoded output bits.

2. The method according to claim 1, wherein the maximum-length segment that has the maximum segment code length of 2\hat{ }^{b} is 1024.

3. The method according to claim 1, wherein the quantity of the maximum-length segments is 0.

4. The method according to claim 1, wherein the quantity of the minimum-length segments is 0.

5. The method according to claim 1, wherein the (b−a+1) types of segments comprise a segment that has a segment code length of 2\hat{ }^{c} among the (b−a+1) types of segment code lengths, and a≤c≤b, c is a positive integer.

6. The method according to claim 1, wherein the (b−a+1) types of segment code lengths comprise: 1024, 512, 256, and 128.

7. The method according to claim 1, wherein the respective quantities of the different types of segments are determined by firstly determining the quantity of the maximum-length segments and lastly determining the quantity of the minimum-length segments, and:
after firstly determining the quantity of the maximum-length segments and before lastly determining the quantity of the minimum-length segments, determining a quantity of a segment that is not the maximum-length segment or the minimum-length segment among the (b−a+1) types of segments.

8. A communication device, comprising at least one memory and at least one processor, wherein the at least one memory is coupled to the at least one processor and storing programming instructions for execution by the at least one processor to perform operations comprising:
performing segmentation of to-be-encoded information bits of a length N into respective quantities of different types of segments, wherein:
the different types of segments are among (b−a+1) types of segments that correspond to (b−a+1) different segment code lengths, wherein:
a and b are positive integers,
the (b−a+1) types of segments comprise a minimum-length segment that has the minimum segment code length of 2\hat{ }^{a} among the (b−a+1) types of segment code lengths, and a maximum-length segment that has the maximum segment code length of 2\hat{ }^{b} among the (b−a+1) types of segment code lengths, and
the respective quantities of the different types of segments are determined based on the length N of the to-be-encoded information bits and a code rate, wherein the respective quantities of the different types of segments are determined by firstly determining a quantity of the maximum-length segments and lastly determining a quantity of the minimum-length segments, and
performing polar code encoding on the respective quantities of the different types of segments of the to-be-encoded information bits to obtain encoded output bits.

9. The communication device according to claim 8, wherein the maximum-length segment that has the maximum segment code length of 2\hat{ }^{b} is 1024.

10. The communication device according to claim 8, wherein the quantity of the maximum-length segments is 0.

11. The communication device according to claim 8, wherein the quantity of the minimum-length segments is 0.

12. The communication device according to claim 8, wherein the (b−a+1) types of segments comprise a segment that has a segment code length of 2 among the (b−a+1) types of segment code lengths, and a≤c≤b, c is a positive integer.

13. The communication device according to claim 8, wherein the (b−a+1) types of segment code lengths comprise: 1024, 512, 256, and 128.

14. The communication device according to claim 8, wherein the respective quantities of the different types of segments are determined by firstly determining the quantity of the maximum-length segments and lastly determining the quantity of the minimum-length segments, and
after firstly determining the quantity of the maximum-length segments and before lastly determining the quantity of the minimum-length segments, determining a quantity of a segment that is not the maximum-length segment or the minimum-length segment among the (b−a+1) types of segments.

15. A non-transitory computer-readable storage medium comprising instructions which, when executed by an apparatus, cause the apparatus to perform operations comprising:
performing segmentation of to-be-encoded information bits of a length N into respective quantities of different types of segments, wherein:
the different types of segments are among (b−a+1) types of segments that correspond to (b−a+1) different segment code lengths, wherein:
a, b, and N are positive integers,
the (b−a+1) types of segments comprise a minimum-length segment that has the minimum segment code length of 2 among the (b−a+1) types of segment code lengths, and a maximum-length segment that has the maximum segment code length of among the (b−a+1) types of segment code lengths, and
the respective quantities of the different types of segments are determined based on the length N of the to-be-encoded information bits and a code rate, wherein the respective quantities of the different types of segments are determined by firstly determining a quantity of the maximum-length segments and lastly determining a quantity of the minimum-length segments, and
performing polar code encoding on the respective quantities of the different types of segments of the to-be-encoded information bits to obtain encoded output bits.

16. The non-transitory computer-readable storage medium according to claim 15, wherein the maximum-length segment that has the maximum segment code length of 2 is 1024.

17. The non-transitory computer-readable storage medium according to claim 15, wherein the quantity of the maximum-length segments is 0 or the quantity of the minimum-length segments is 0.

18. The non-transitory computer-readable storage medium according to claim 15, wherein the (b−a+1) types of segments comprise a segment that has a segment code length of 2\hat{ }^{b} among the (b−a+1) types of segment code lengths, and a≤c≤b, c is a positive integer.

19. The non-transitory computer-readable storage medium according to claim 15, wherein the (b−a+1) types of segment code lengths comprise: 1024, 512, 256, and 128.

20. The non-transitory computer-readable storage medium according to claim 15, wherein the respective quantities of the different types of segments are determined by firstly determining the quantity of the maximum-length segments and lastly determining the quantity of the minimum-length segments, and
after firstly determining the quantity of the maximum-length segments and before lastly determining the quantity of the minimum-length segments, determining a quantity of a segment that is not the maximum-length segment or the minimum-length segment among the (b−a+1) types of segments.
